(19) United States
(12) Patent Application Publication
(10) Pub. No.: US 2017/0290042 A1
(43) Pub. Date: Oct. 5, 2017

(54) SCHEDULING REQUEST TRANSMISSION TO REQUEST RESOURCES FOR A BUFFER STATUS REPORT

(71) Applicant: QUALCOMM Incorporated, San Diego, CA (US)

(72) Inventors: Muhammad Nazmul Islam, Edison, NJ (US); Sundar Subramanian, Bridgewater, NJ (US); Juergen Cezanne, Ocean Township, NJ (US); Junyi Li, Chester, NJ (US); Ashwin Sampath, Skillman, NJ (US); Tao Luo, San Diego, CA (US)

(21) Appl. No.: 15/478,933

(22) Filed: Apr. 4, 2017

Related U.S. Application Data
(63) Continuation-in-part of application No. 15/395,189, filed on Dec. 30, 2016.
(60) Provisional application No. 62/318,211, filed on Apr. 5, 2016.
(60) Provisional application No. 62/458,544, filed on Feb. 13, 2017.

(51) Int. Cl. H04W 72/12; H04L 5/00; H04W 74/08; H04W 72/04

(52) U.S. Cl. CPC H04W 72/1252; H04W 72/0413; H04L 5/0048; H04W 74/0833

(57) ABSTRACT

A UE may receive a reference signal or directional synchronization subframe from a base station and transmit a scheduling request to the base station using a resource based on the reference signal or directional synchronization subframe. The scheduling request may enable a base station to grant the UE resources to send a buffer status report (BSR). The resource may be associated with a random access channel (RACH) time period. The UE may also transmit a scheduling request within a frequency region of the RACH time period. The scheduling request may be transmitted based on a received indication of a set of subcarrier, a cyclic shift, or a sequence index. In some examples, the resources used by the UE to send the BSR may include physical uplink shared channel (PUSCH) or physical uplink control channel (PUCCH) resources.

### CROSS REFERENCES

The present Application for Patent is a Continuation-in-Part of U.S. patent application Ser. No. 15/395,189 by Islam et al., entitled “Scheduling Request Transmission to Request Resources for Transmitting Buffer Status Report,” filed Dec. 30, 2016, which claims priority to U.S. Provisional Patent Application No. 62/318,211 by Islam, et al., entitled “Scheduling Request Transmission To Request Resources for Transmitting Buffer Status Report,” filed Apr. 5, 2016, and present Application for Patent also claiming priority to U.S. Provisional Patent Application No. 62/458,544 by Islam et al., entitled “Scheduling Request Transmission to Request Resources for A Buffer Status Report,” filed Feb. 13, 2017 assigned to the assignee hereof.

### BACKGROUND

The following relates generally to wireless communication, and more specifically to a scheduling request transmission, for example, to request resources for a buffer status report (BSR).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE).

In some wireless communications systems, a UE may indicate to a base station that it has uplink data to transmit by sending a BSR. However, if sufficient uplink resources are not available to transmit the BSR, the UE may not be able to immediately indicate the pending uplink data. For example, if a UE is operating in a system that utilizes directional downlink control transmissions, the UE may not receive an indication in a physical downlink control channel (PDCCH) of where to transmit the BSR. As a result, communication may be delayed until the UE is able to obtain the resources to provide the BSR to the base station.

### SUMMARY

A user equipment (UE) may receive a directional synchronization subframe from a base station and transmit a scheduling request to the base station during a time period based on the directional synchronization subframe. In other examples, the UE may receive a reference signal from the base station and transmit the scheduling request using resources identified based on the reference signal. The time period or resources may be associated with a random access channel (RACH). The scheduling request may enable a base station to grant the UE resources to send a buffer status report (BSR). The UE may also transmit a scheduling request within a frequency region of the RACH time period. The scheduling request may be transmitted based on a received indication of a set of subcarrier, a cyclic shift, or a sequence index. In some examples, the resources used by the UE to send the BSR may include physical uplink shared channel (PUSCH) or physical uplink control channel (PUCCH) resources.

A method of wireless communication is described. The method may include receiving a directional synchronization subframe from a base station, identifying a time period for transmitting a scheduling request to the base station, wherein the time period for transmitting the scheduling request is based at least in part on the directional synchronization subframe, and transmitting the scheduling request to the base station during the time period.

An apparatus for wireless communication is described. The apparatus may include means for receiving a directional synchronization subframe from a base station, means for identifying a time period for transmitting a scheduling request to the base station, wherein the time period for transmitting the scheduling request is based at least in part on the directional synchronization subframe, and means for transmitting the scheduling request to the base station during the time period.

Another apparatus for wireless communication is described. The apparatus may include a processor, memory in electronic communication with the processor, and instructions stored in the memory. The instructions may be operable to cause the processor to receive a directional synchronization subframe from a base station, identify a time period for transmitting a scheduling request to the base station, wherein the time period for transmitting the scheduling request is based at least in part on the directional synchronization subframe, and transmit the scheduling request to the base station during the time period.

Another non-transitory computer readable medium for wireless communication is described. The non-transitory computer-readable medium may include instructions operable to cause a processor to receive a directional synchronization subframe from a base station, identify a time period for transmitting a scheduling request to the base station, wherein the time period for transmitting the scheduling request is based at least in part on the directional synchronization subframe, and transmit the scheduling request to the base station during the time period.

Some examples of the method, apparatus, and non-transitory computer-readable medium described above may further include processes, features, means, or instructions for receiving a grant for transmitting a BSR in response to the scheduling request. Some examples of the method, apparatus, and non-transitory computer-readable medium described above may further include processes, features, means, or instructions for transmitting the BSR to the base station using resources indicated in the grant.

In some examples of the method, apparatus, and non-transitory computer-readable medium described above, the resources indicated in the grant comprise PUSCH resources, PUCCH resources, or both.

In some examples of the method, apparatus, and non-transitory computer-readable medium described above, the directional synchronization subframe comprises a set of directional synchronization signals.

Some examples of the method, apparatus, and non-transitory computer-readable medium described above may further include processes, features, means, or instructions for identifying a directional signal from the set of directional synchronization signals, wherein the time period for transmitting the scheduling request may be based at least in part on the identified directional signal.

In some examples of the method, apparatus, and non-transitory computer-readable medium described above, each set of directional synchronization signals comprises a primary synchronization signal (PSS), a secondary synchronization signal (SSS), a beam reference signal (BRS), or any combination thereof.

Some examples of the method, apparatus, and non-transitory computer-readable medium described above may further include processes, features, means, or instructions for receiving an indication of at least one of a cyclic shift, a set of subcarriers, or a sequence index from the base station, wherein the scheduling request may be transmitted using the transmission time, the set of subcarriers, the cyclic shift, the sequence index, or a combination thereof.

In some examples of the method, apparatus, and non-transitory computer-readable medium described above, the scheduling request comprises a sequence repeated a plurality of times over a plurality of symbol periods.

In some examples of the method, apparatus, and non-transitory computer-readable medium described above, the time period for transmitting the scheduling request may be associated with a RACH.

Some examples of the method, apparatus, and non-transitory computer-readable medium described above may further include processes, features, means, or instructions for identifying a frequency region associated with the RACH and a frequency region associated with scheduling requests that does not overlap with the frequency region associated with the RACH, wherein the scheduling request may be transmitted using resources located within the frequency region associated with scheduling requests.

Some examples of the method, apparatus, and non-transitory computer-readable medium described above may further include processes, features, means, or instructions for identifying a cyclic prefix length for the scheduling request, wherein the cyclic prefix length comprises a long cyclic prefix length associated with the RACH or a short cyclic prefix length associated with non-RACH transmissions.

A method of wireless communication is described. The method may include transmitting a directional synchronization subframe to a UE and receiving a scheduling request from the UE during a time period selected by the UE based at least in part on the directional synchronization subframe.

An apparatus for wireless communication is described. The apparatus may include means for transmitting a directional synchronization subframe to a UE and means for receiving a scheduling request from the UE during a time period selected by the UE based at least in part on the directional synchronization subframe.

Another apparatus for wireless communication is described. The apparatus may include a processor, memory in electronic communication with the processor, and instructions stored in the memory. The instructions may be operable to cause the processor to transmit a directional synchronization subframe to a UE and receive a scheduling request from the UE during a time period selected by the UE based at least in part on the directional synchronization subframe.

A non-transitory computer readable medium for wireless communication is described. The non-transitory computer-readable medium may include instructions operable to cause a processor to transmit a directional synchronization subframe to a user equipment (UE) and receive a scheduling request from the UE during a time period selected by the UE based at least in part on the directional synchronization subframe.

Some examples of the method, apparatus, and non-transitory computer-readable medium described above may further include processes, features, means, or instructions for transmitting a grant for transmitting a BSR in response to the scheduling request. Some examples of the method, apparatus, and non-transitory computer-readable medium described above may further include processes, features, means, or instructions for receiving the BSR from the UE using resources indicated in the grant.

In some examples of the method, apparatus, and non-transitory computer-readable medium described above, the resources indicated in the grant comprises PUSCH resources, PUCCH resources, or both.

In some examples of the method, apparatus, and non-transitory computer-readable medium described above, the time period for receiving the scheduling request may be associated with a RACH.

Some examples of the method, apparatus, and non-transitory computer-readable medium described above may further include processes, features, means, or instructions for identifying a frequency region associated with the RACH and a frequency region associated with scheduling requests that does not overlap with the frequency region associated with the RACH, wherein the scheduling request may be received using resources located within the frequency region associated with scheduling requests.

Some examples of the method, apparatus, and non-transitory computer-readable medium described above may further include processes, features, means, or instructions for identifying a cyclic prefix length for the scheduling request, wherein the cyclic prefix length comprises a long cyclic prefix length associated with the RACH or a short cyclic prefix length associated with non-RACH transmissions.

Some examples of the method, apparatus, and non-transitory computer-readable medium described above may further include processes, features, means, or instructions for transmitting an indication of at least one of a cyclic shift, a set of subcarriers, or a sequence index to the UE, wherein the scheduling request may be received using the cyclic shift, the set of subcarriers, the sequence index, or combinations thereof.

In some examples of the method, apparatus, and non-transitory computer-readable medium described above, the scheduling request comprises a sequence repeated a plurality of times over a plurality of symbol periods.

A method of wireless communication is described. The method may include receiving a reference signal from a base station, identifying a resource for transmitting a scheduling request to the base station, wherein the resource for transmitting the scheduling request is based at least in part on the reference signal, and transmitting the scheduling request to the base station using the resource.

An apparatus for wireless communication is described. The apparatus may include means for receiving a reference signal from a base station, means for identifying a resource for transmitting a scheduling request to the base station, wherein the resource for transmitting the scheduling request is based at least in part on the reference signal, and means for transmitting the scheduling request to the base station using the resource.

Another apparatus for wireless communication is described. The apparatus may include a processor, memory in electronic communication with the processor, and instructions stored in the memory. The instructions may be operable to cause the processor to receive a reference signal from a base station, identify a resource for transmitting a scheduling request to the base station, wherein the resource for transmitting the scheduling request is based at least in part on the reference signal, and transmit the scheduling request to the base station using the resource.

A non-transitory computer readable medium for wireless communication is described. The non-transitory computer-readable medium may include instructions operable to cause a processor to receive a reference signal from a base station, identify a resource for transmitting a scheduling request to the base station, wherein the resource for transmitting the scheduling request is based at least in part on the reference signal, and transmit the scheduling request to the base station using the resource.

Some examples of the method, apparatus, and non-transitory computer-readable medium described above may further include processes, features, means, or instructions for receiving a grant for transmitting a BSR in response to the scheduling request. Some examples of the method, apparatus, and non-transitory computer-readable medium described above may further include processes, features, means, or instructions for transmitting the BSR to the base station using the resource indicated in the grant.

In some examples of the method, apparatus, and non-transitory computer-readable medium described above, the resource indicated in the grant comprise PUSCH resources, PUCCH resources, or both.

In some examples of the method, apparatus, and non-transitory computer-readable medium described above, the reference signal from the base station comprises one or more reference signals from a set of reference signals.

Some examples of the method, apparatus, and non-transitory computer-readable medium described above may further include processes, features, means, or instructions for identifying a reference signal from the set of reference signals, wherein the resource for transmitting the scheduling request may be based at least in part on the reference signal from the set of reference signals.

In some examples of the method, apparatus, and non-transitory computer-readable medium described above, the reference signal from the set of reference signals may be at least one of a PSS, an SSS, a DMRS for a PBCH, a BRS, CSI-RS, a MRS, a CRS, or a combination thereof.

Some examples of the method, apparatus, and non-transitory computer-readable medium described above may further include processes, features, means, or instructions for determining, based at least in part on the resource, at least one of a transmission time, a set of subcarriers, a cyclic shift, or a sequence index, wherein the scheduling request may be transmitted using the transmission time, the set of subcarriers, the cyclic shift, the sequence index, or a combination thereof.

Some examples of the method, apparatus, and non-transitory computer-readable medium described above may further include processes, features, means, or instructions for receiving, from the base station, at least one of a transmission time, a set of subcarriers, a cyclic shift, a sequence index, where the scheduling request is transmitted using the transmission time, the set of subcarriers, the cyclic shift, the sequence index, or a combination thereof.

In some examples of the method, apparatus, and non-transitory computer-readable medium described above, the scheduling request comprises a sequence repeated a plurality of times over a plurality of symbol periods.

In some examples of the method, apparatus, and non-transitory computer-readable medium described above, the scheduling request comprises a short PUCCH format.

In some examples of the method, apparatus, and non-transitory computer-readable medium described above, the resource for transmitting the scheduling request may be associated with a RACH.

A method of wireless communication is described. The method may include transmitting a reference signal to a UE and receiving a scheduling request from the UE using a resource selected by the UE based at least in part on the reference signal.

An apparatus for wireless communication is described. The apparatus may include means for transmitting a reference signal to a UE and means for receiving a scheduling request from the UE using a resource selected by the UE based at least in part on the reference signal.

Another apparatus for wireless communication is described. The apparatus may include a processor, memory in electronic communication with the processor, and instructions stored in the memory. The instructions may be operable to cause the processor to transmit a reference signal to a UE and receive a scheduling request from the UE using a resource selected by the UE based at least in part on the reference signal.

A non-transitory computer readable medium for wireless communication is described. The non-transitory computer-readable medium may include instructions operable to cause a processor to transmit a reference signal to a UE and receive a scheduling request from the UE using a resource selected by the UE based at least in part on the reference signal.

Some examples of the method, apparatus, and non-transitory computer-readable medium described above may further include processes, features, means, or instructions for transmitting a grant for transmitting a BSR in response to the scheduling request. Some examples of the method, apparatus, and non-transitory computer-readable medium described above may further include processes, features, means, or instructions for receiving the BSR from the UE using resources indicated in the grant.

In some examples of the method, apparatus, and non-transitory computer-readable medium described above, the resources indicated in the grant comprises PUSCH resources, PUCCH resources, or both.

In some examples of the method, apparatus, and non-transitory computer-readable medium described above, the resource for receiving the scheduling request may be associated with a RACH.

Some examples of the method, apparatus, and non-transitory computer-readable medium described above may further include processes, features, means, or instructions for identifying a frequency region associated with the RACH and a frequency region associated with scheduling requests that does not overlap with the frequency region associated with the RACH, wherein the scheduling request may be received using resources located within the frequency region associated with scheduling requests.

Some examples of the method, apparatus, and non-transitory computer-readable medium described above may further include processes, features, means, or instructions for identifying a cyclic prefix length for the scheduling request, wherein the cyclic prefix length comprises a long cyclic prefix length associated with the RACH or a short cyclic prefix length associated with non-RACH transmissions.

Some examples of the method, apparatus, and non-transitory computer-readable medium described above may further include processes, features, means, or instructions for transmitting an indication of at least one of a cyclic shift, a set of subcarriers, or a sequence index to the UE, wherein the scheduling request may be received using the cyclic shift, the set of subcarriers, the sequence index, or combinations thereof.

In some examples of the method, apparatus, and non-transitory computer-readable medium described above, the scheduling request comprises a sequence repeated a plurality of times over a plurality of symbol periods.

### BRIEF DESCRIPTION OF THE DRAWINGS

FIG. 1 illustrates an example of a system for wireless communication that supports scheduling request transmission to request resources for, for example, a buffer status report (BSR) in accordance with aspects of the present disclosure;

FIG. 2 illustrates an example of a wireless communications system that supports scheduling request transmission to request resources for, for example, a BSR in accordance with aspects of the present disclosure;

FIG. 3 illustrates an example of a random access channel (RACH) subframe in a system that supports scheduling request transmission to request resources for, for example, a BSR in accordance with aspects of the present disclosure;

FIG. 4 illustrates an example of a process flow in a system that supports scheduling request transmission to request resources for, for example, a BSR in accordance with aspects of the present disclosure;

FIGS. 5 through 7 show block diagrams of a device that supports scheduling request transmission to request resources for, for example, a BSR in accordance with aspects of the present disclosure;

FIG. 8 illustrates a block diagram of a system including a user equipment (UE) that supports scheduling request transmission to request resources for, for example, a BSR in accordance with aspects of the present disclosure;

FIGS. 9 through 11 show block diagrams of a device that supports scheduling request transmission to request resources for, for example, a BSR in accordance with aspects of the present disclosure;

FIG. 12 illustrates a block diagram of a system including a base station that supports scheduling request transmission to request resources for, for example, a BSR in accordance with aspects of the present disclosure; and

FIGS. 13 through 24 illustrate methods for scheduling request transmission to request resources for, for example, a BSR in accordance with aspects of the present disclosure.

### DETAILED DESCRIPTION

Some wireless communication systems may operate in millimeter wave (mmW) frequency ranges, e.g., 28 GHz, 40 GHz, 60 GHz, etc. Wireless communication at these frequencies may be associated with increased signal attenuation (e.g., path loss), which may be influenced by various factors, such as temperature, barometric pressure, diffraction, etc. As a result, signal processing techniques, such as beamforming, may be used to coherently combine energy and overcome the path losses at these frequencies. User equipments (UEs) may use random access procedures to establish a connection and communicate with a network. For example, a UE may determine that it has data to send and use random access procedures to initiate a data transfer with a base station.

In some cases, a UE may send transmissions to a base station, such as a buffer status report (BSR), to indicate that the UE has uplink data to send. However, there may not be enough resources available to transmit the BSR when the UE has an opportunity to do so. As a result, the UE may send a scheduling request seeking an uplink grant from the base station. Due to the increased amount of path loss in mmW communications systems, transmissions from the UE may be beamformed. Thus, uplink control channels may be received at a base station in a directional manner from multiple UEs. In cases where uplink channel transmission may be dynamically scheduled, UEs associated with a duration of inactivity may not have uplink control channel resources available to transmit a scheduling request, which may impede its ability to efficiently communicate.

In some cases, a UE may transmit a scheduling request during a time period allocated for random access procedures. For example, the UE may identify a random access channel subframe, and transmit the scheduling request during the random access subframe. In some examples, the UE may identify resources for transmitting the scheduling request based on a received reference signal from the base station. The scheduling request may be used to obtain a grant for uplink channel resources (e.g., a physical uplink control channel (PUCCH) or a physical uplink shared channel (PUSCH)) to be used for the transmission of a BSR. The scheduling request may be transmitted using resources in the random access subframe that are different from the resources used for a random access message. For example, a region of unoccupied bandwidth in a random access subframe may be used to transmit the scheduling request, where a different frequency bandwidth is allocated for random access messages.

Aspects of the disclosure are initially described in the context of a wireless communication system. Further examples are then provided for transmitting a scheduling request in a random access subframe. Aspects of the disclosure are further illustrated by and described with reference to apparatus diagrams, system diagrams, and flowcharts that relate to scheduling request transmission to request resources for a BSR.

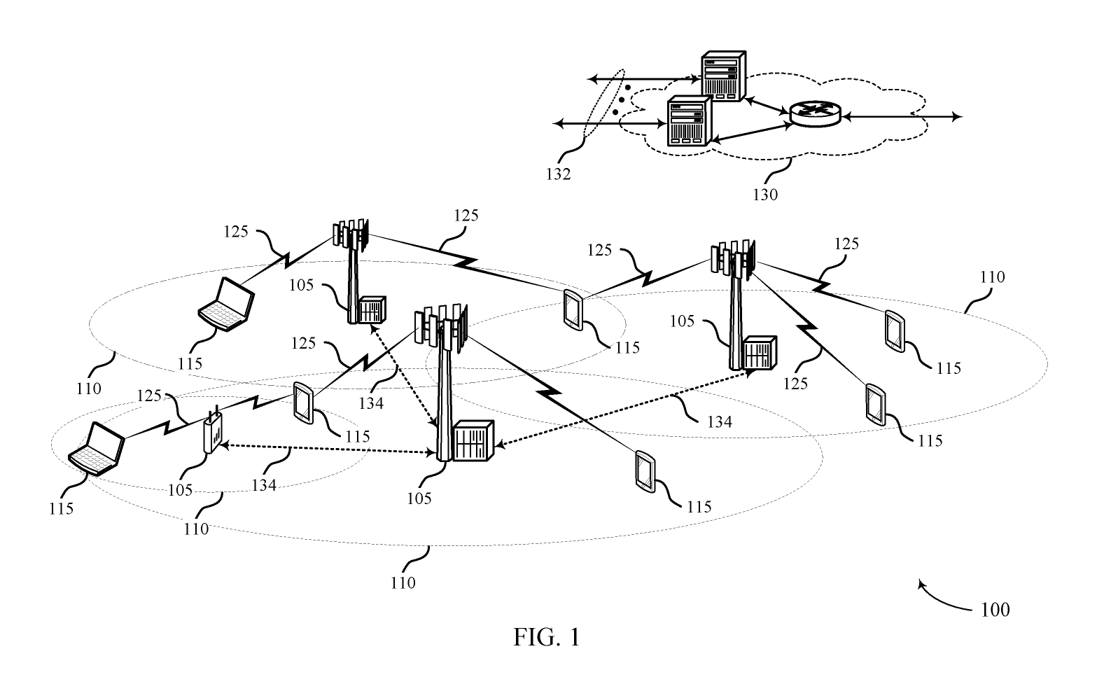

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. Wireless communications system 100 may represent an example of a system where a UE 115 efficiently acquires uplink resources by transmitting a scheduling request in a random access subframe.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, an machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

Some wireless communication systems may operate in mmW frequency ranges, e.g., 28 GHz, 40 GHz, 60 GHz, etc. Wireless communication at these frequencies may be associated with increased signal attenuation (e.g., path loss), which may be influenced by various factors, such as temperature, barometric pressure, diffraction, etc. As a result, signal processing techniques, such as beamforming, may be used to coherently combine energy and overcome the path losses at these frequencies.

In mmW systems, synchronization signals may be beam-formed to meet a certain link budget (e.g., an accounting of gains and losses associated with transmitters and receivers when communicating over a medium). In such cases, base stations 105 may use multiple antenna ports connected to subarrays of antennas to form the beams in various directions using a number of analog weight factors. A base station 105 may thus transmit synchronization symbols in multiple directions, where the direction may change in each symbol of a synchronization subframe.

UEs 115 may use random access procedures to establish a connection and communicate with a network. For example, a UE 115 may determine that it has data to send and use random access procedures to initiate a data transfer with a base station 105. In some cases, one or more UEs 115 may seek resources to send data and subsequently transmit a random access sequence or preamble to the base station 105. The base station 105 may detect the random access sequence transmissions from the one or more UEs 115 and assign resources for communication. Random access message transmissions may be based on the synchronization signal received from a base station 105. For example, the transmission of synchronization symbols from a base station 105 may be used by a UE 115 to identify timing and/or frequency resources to send the random access message.

In some cases, a UE 115 may identify a specific beam associated with a synchronization signal (e.g., a beam with the highest SNR) and further identify a symbol during which that beam was transmitted (e.g., using a symbol index). The UE 115 may then select a number of symbols based on a symbol index to transmit a random access message based on the symbol associated with the synchronization beam. For example, a UE 115 may determine a synchronization beam was transmitted during a first symbol and may correspondingly transmit the random access message during the first two symbols of a random access subframe. A different UE 115 may identify a second synchronization beam and transmit a random access message on different symbols. If both UEs 115 identify the same synchronization beam (transmitted during the same symbol) they may attempt to transmit the random access message using the same resources. However, when random access messages are spread over multiple symbols of a random access subframe, the base station 105 may differentiate between the UEs 115 and proceed to assign resources. In some examples, a UE 115 may randomly select a subcarrier of a radio frequency band or randomly select a component carrier to transmit the random access message.

In some cases, a UE 115 may send transmissions to a base station 105, such as a BSR, to indicate that it has uplink data to send. For example, a UE 115 may determine that it has uplink data to transmit and transmit a BSR to a base station 105 to obtain uplink resources. In some cases, the UE 115 may utilize a PUSCH to transmit the BSR. However, there may not be enough resources available to transmit the BSR when a UE 115 has an opportunity to do so. As a result, the UE 115 may send a scheduling request seeking an uplink grant from the base station 105.

Scheduling requests may be transmitted using an uplink control channel (e.g., a PUCCH). Alternatively, if control channel resources are not allocated to the UE 115 or the control channel is not configured for a scheduling request, a random access procedure may be used by the UE 115 (e.g., where a random sequence or preamble is transmitted to enable the base station 105 to identify the UE 115). Due to the increased amount of path loss in mmW communications systems, transmissions from the UE 115 may be beamformed. Thus, uplink control channels may be received at a base station 105 in a directional manner from multiple UEs 115.

As described herein, a UE 115 may transmit a scheduling request to a base station 105 using resources (e.g., identified based on downlink reference signals) or during a time period, either of which may be associated with a RACH, where the scheduling request may enable a base station 105 to grant the UE 115 resources to send a BSR. In some cases, the UE 115 may identify the time period based on synchronization information transmitted by the base station 105. The UE 115 may also transmit a scheduling request within a frequency region of the time period. The scheduling request may be transmitted based on a received indication of a set of subcarrier, a cyclic shift, or a sequence index. In some examples, the resources used by the UE 115 to send the BSR may include PUSCH or PUCCH resources.

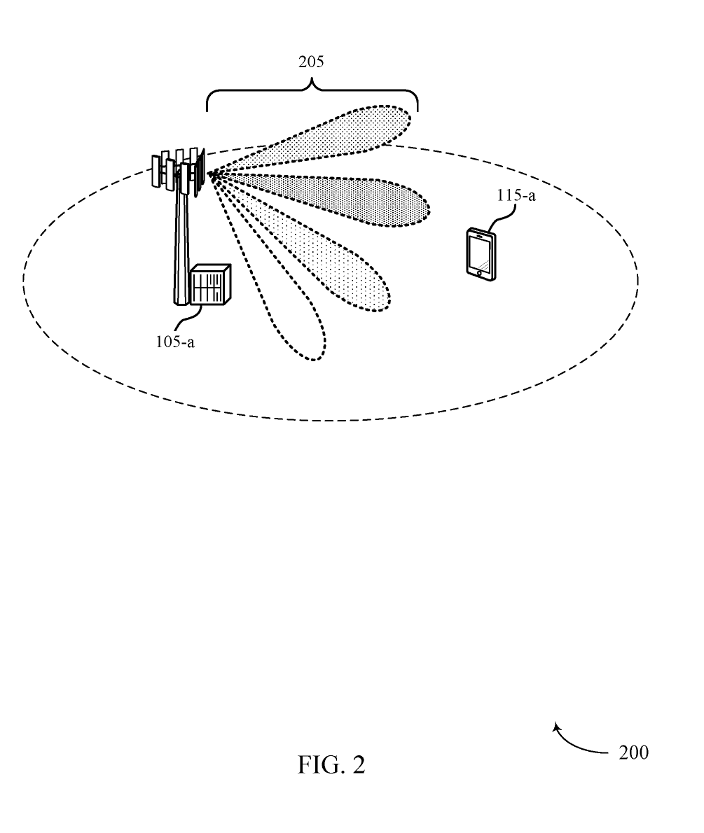

FIG. 2 illustrates an example of a wireless communications system 200 for scheduling request transmission to request resources for a BSR. Wireless communications system 200 may include base station 105-a and UE 115-a, which may be examples of the corresponding devices described with reference to FIG. 1. Wireless communications system 200 may illustrate an example of transmitting a scheduling request during a random access subframe.

In wireless communications system 200, UE 115-a may transmit a scheduling request during a time period allocated for random access procedures. For example, UE 115-a may identify a random access subframe, and transmit the scheduling request during the random access subframe. In some examples, UE 115-a may transmit the scheduling request during resources identified based on a received reference signal from base station 105-a. The scheduling request may be used to obtain a grant for uplink channel resources (e.g., PUCCH or PUSCH) to be used for the transmission of a BSR. In other embodiments, UE 115-a may receive a downlink reference signal from base station 105-a, determine a resource for the scheduling request transmission based on the downlink reference signal, and transmit the scheduling request using the resource.

In some examples, the scheduling request may be transmitted using resources in the random access subframe that are different from the resources used for a random access message. For example, a region of unoccupied bandwidth in a random access subframe may be used to transmit the scheduling request, where a different frequency bandwidth is allocated for random access messages. In some cases, the transmission of synchronization beams 205 from a base station 105-a may be used by UE 115-a to identify timing and/or frequency resources to send a random access subframe. In such cases, a certain synchronization beam or a set of synchronization beams may correspond to different symbols during which the scheduling request may be transmitted to the base station.

In some cases, the frequency region in the random access subcarrier used for the scheduling request may be associated with a shorter cyclic prefix in comparison to the region used for random access messages. For example, a timing error associated with a round trip time or delay spread may already be corrected when UE 115-a transmits the scheduling request. As a result, a comparatively larger number of cyclic shifts (e.g., up to 12 cyclic shifts) may be used for the scheduling request frequency region. Base station 105-a may assign a cyclic shift and a frequency region (such as one or more subcarriers) to be used by UE 115-a for the transmission of the scheduling request.

In some examples, base station 105-a may sweep synchronization signals in different beam directions. UE 115-a may measure the quality of reference signal and select a suitable beam. If UE time is synchronized, UE 115-a may transmit a scheduling request in a scheduling request frequency region, where a high number of UEs 115 may be accommodated. If UE time is not synchronized, UE 115-a may transmit the scheduling request based on a RACH region.

Wireless communications system 200 may support a scheduling request region in a multi-beam communication configuration. For example, UE 115-a may be configured with resources for transmitting a scheduling request in a region where base station 105-a is listening from all or some direction (e.g., in a random access slot). A resource for a scheduling request may be selected by UE 115-a based on the quality of downlink reference signals. In some examples, the downlink reference signals may include synchronization signals such as a primary synchronization signal (PSS), a secondary synchronization signal (SSS), or a demodulation reference signal (DMRS) for a physical broadcast channel (PBCH). In some examples, the resource may be allocated as symbols to UE 115-a. In some examples, UE 115-a may transmit a scheduling request using a same baseline sequence as a RACH sequence. In some cases, a higher number of cyclic shifts may be accommodated to transmit the scheduling request.

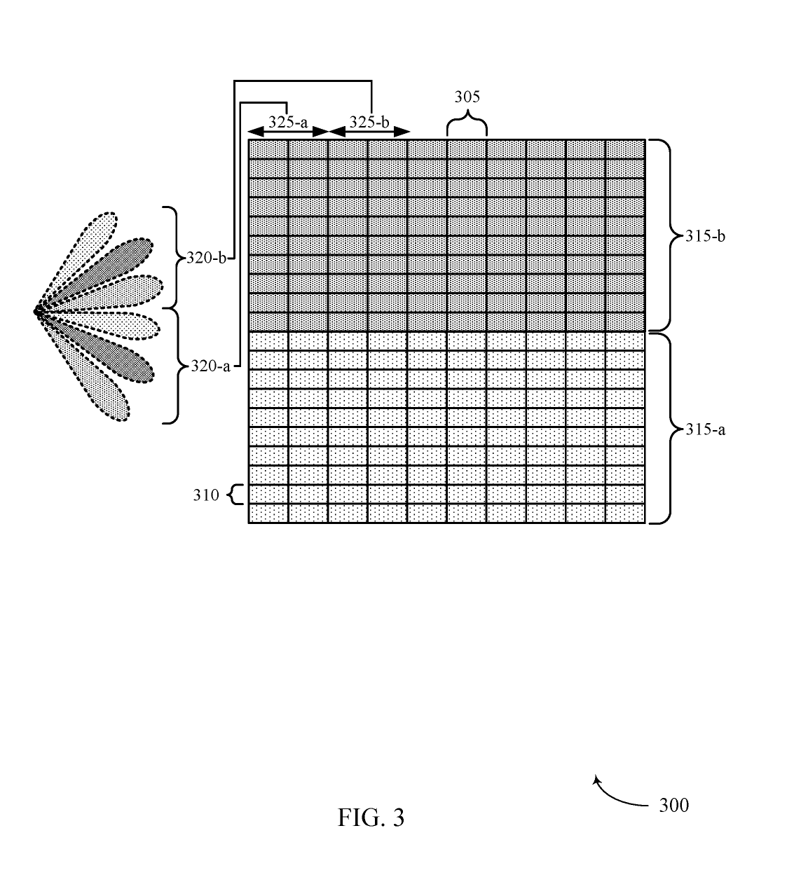

FIG. 3 illustrates an example of a RACH subframe 300 in a system that supports scheduling request transmission to request resources for a BSR. In some cases, RACH subframe 300 may represent aspects of techniques performed by a UE 115 or base station 105 as described with reference to FIGS. 1-2. RACH subframe 300 may illustrate an example of the transmission of a scheduling request during a RACH time period to enable efficient uplink resource allocation.

RACH subframe 300 may include multiple symbols 305 and subcarriers 310 used by a UE 115 for the transmission of various signals. In some cases, RACH subframe 300 may include different radio frequency regions 315, where each frequency region my include multiple subcarriers or frequency regions 310. In some cases, these radio frequency regions 315 may be associated with different types of transmissions. For example, a first subcarrier 310-a may be used for a random access message transmissions, where a random access message may be transmitted using, or spread across, multiple symbols 305. A second subcarrier 310-b may be used for the transmission of signals that are not associated with random access processes.

In an example, second frequency region 315-b may be used for the transmission of scheduling requests during the same RACH time period. In some examples, the UE 115 may transmit the scheduling request using resources identified based on a downlink reference signal. For example, A UE 115 may use second subcarrier 310-b to transmit a scheduling request over multiple symbols 305 while the first frequency region may be reserved for RACH preamble transmissions. The first frequency region 315-a and the second frequency region 315-b may not overlap.

A scheduling request preamble may include a cyclic prefix, for example of length T_{CP} and a sequence part of length T_{SEQ}. T_{CP} and T_{SEQ} may each have the same values as their respective RACH preamble counterparts. In some examples, T_{CP} may be 656 T_{S} long and T_{SEQ} may be 2048 T_{S} long. The scheduling request preamble may be generated based on Zadoff-Chu sequences. The network may configure a set of preamble sequences for the UE 115. UEs 115 in the network may cyclically shift based on a scheduling request sequence length (e.g., 2048 samples) and a maximum delay spread (e.g., 144 samples). The network may allocate resources sufficient to allow, for example, up to 12 cyclic shifts among the UEs 115. The RACH subframe 300 may provide 8 scheduling request bands, where each scheduling request band may occupy 6 resource blocks. In some examples, the band used by the UE 115 may be based on a number of scheduling requests.

In some cases, a UE 115 may use a synchronization beam to identify a symbol index to transmit the scheduling request. For example, multiple synchronization beams may be sent by a base station 105. A first subset of synchronization beams 320-a may be identified by the UE 115 and a symbol index may be used to send a first scheduling request over a first symbol group 325-a. Similarly, a second subset of synchronization beams 320-b may provide a different symbol index, and the UE 115 may transmit the scheduling request using a second symbol group 325-b. In some cases, a certain synchronization beam (e.g., a beam within either the first subset of synchronization beams 320-a or the second subset of synchronization beams 320-b) may be identified by the UE 115 and used to identify the symbol index. In some cases, the beam may be identified as having the greatest signal-to-noise ratio (SNR). Additionally or alternatively, the base station 105 may also provide the UE with a cyclic shift and a subcarrier region to be used to transmit the scheduling request within the second frequency region 315-b.

A UE 115 may identify parameters to determine symbols of a RACH signal. For example, the UE 115 may identify a system frame number (SFN), a beam reference signal (BRS) transmission period, a number of symbols (N_{RACH}) during the RACH subframe 300 for which the base station may apply different reception beams, a number of RACH subframes (M) in a radio frame, an index of a RACH subframe (m), and the symbol with the strongest sync beam (S_{Sync}^{BestBeam}).

In some examples, RACH subframe 300 may use the same beams as a synchronization subframe and in the same order. For example, if an mth RACH subframe occurs within in radio frame with the same SFN, the m-th RACH subframe may use the beams of the synchronization symbols identified by the set

(M*SFN*N_{RACH}+m*N_{RACH}+(0:N_{RACH}−1))mod(N_{BRS}), m∈{0, . . . M−1}.

If S_{Sync}^{BestBeam} is included in the set of symbols, the UE 115 may transmit a RACH preamble during the RACH subframe 300. The transmission may begin at symbol

l=((S_{Sync}^{BestBeam}−(SFN*M*N_{RACH}+m*N_{RACH})mod(N_{BRS}))mod(N_{BRS}))*Nᵣₑₚ,

where Nᵣₑₚ may denote the number of symbols used for a single RACH transmission.

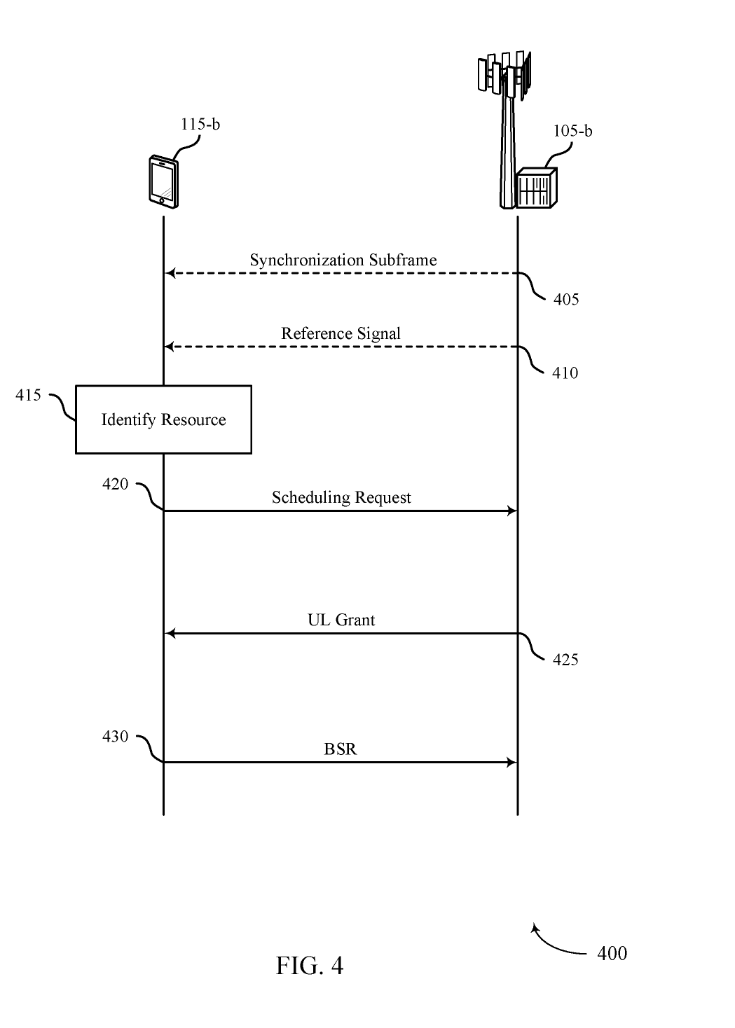

FIG. 4 illustrates an example of a process flow 400 that supports scheduling request transmission to request resources for a BSR in accordance with various aspects of the present disclosure. Process flow 400 may include base station 105-b and UE 115-b, which may be examples of the corresponding devices described with reference to FIG. 1-2.

In some examples, UE 115-b may receive a directional synchronization subframe from base station 105-b at step 405. In some examples, the directional synchronization subframe may include a set of directional synchronization signals, and a time period (e.g., for transmitting a scheduling request) may be based on identifying a directional signal from the set of directional synchronization signals. In some cases, the directional synchronization signals may contain one or more combinations of a primary synchronization signal, a secondary synchronization signal, or a beam reference signal. In some examples, the time period may be associated with a RACH. The time period may be identified based on the received directional synchronization subframe. In such cases, UE 115-b may identify the directional synchronization subframe from a set of directional subframes transmitted by base station 105-b based on a signal strength of the directional synchronization subframe.

In other implementations, UE 115-b may receive a reference signal from base station 105-b at step 410. In some examples, the reference signal from the base station comprises one or more reference signals from a set of reference signals, and UE 115-b may identify a reference signal from the set of reference signals. The reference signal from the set of reference signals is at least one of a PSS, an SSS, a DMRS for PBCH, a beam reference signal (BRS), channel state indicator reference signal (CSI-RS), a mobility reference signal (MRS), a cell specific reference signal (CRS), or a combination thereof.

At step 415, UE 115-b may identify a resource for transmitting a scheduling request. In some examples, the resource may be associated with a RACH. In some implementations, UE 115-b may identify a time period for transmitting a scheduling request at step 415.

At step 420, UE 115-b may transmit a scheduling request to a base station during the time period associated with the RACH or by using the resource indicated at step 405 or 410. In some examples, UE 115-b may receive, from base station 105-b, at least one of a transmission time, a cyclic shift, a set of subcarriers, or a sequence index from the base station, where the scheduling request is transmitted using the transmission time, the cyclic shift, the set of subcarriers, the sequence index, or a combination thereof. Additionally or alternatively, UE 115-b may determine, based on the resource, at least one of a transmission time, a set of subcarriers, a cyclic shift, or a sequence index, where the scheduling request is transmitted using the transmission time, the set of subcarriers, the cyclic shift, the sequence index, or a combination thereof. UE 115-b may identify a frequency region associated with the RACH and a frequency region associated with scheduling requests that does not overlap with the frequency region associated with the RACH, where the scheduling request is transmitted using resources located within the frequency region associated with scheduling requests. In some cases, the scheduling request includes a sequence repeated a plurality of times over a plurality of symbol periods.

At step 425, base station 105-b may transmit, and UE 115-b may receive, a grant for transmitting a BSR in response to the scheduling request. In some cases, the resources indicated in the grant may include PUSCH resources, PUCCH resources, or both. At step 430, UE 115-b may transmit the BSR to base station 105-b using resources indicated in the grant.

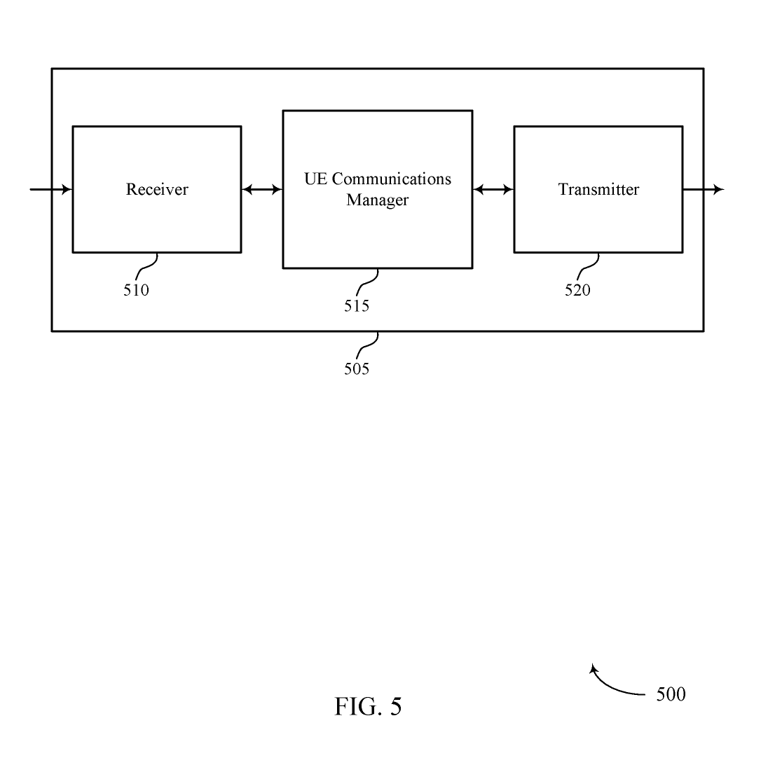

FIG. 5 shows a block diagram 500 of a wireless device 505 that supports scheduling request transmission to request resources for a BSR in accordance with various aspects of the present disclosure. Wireless device 505 may be an example of aspects of a UE 115 as described with reference to FIG. 1. wireless device 505 may include receiver 510, UE communications manager 515, and transmitter 520. wireless device 505 may also include a processor. Each of these components may be in communication with one another (e.g., via one or more buses).

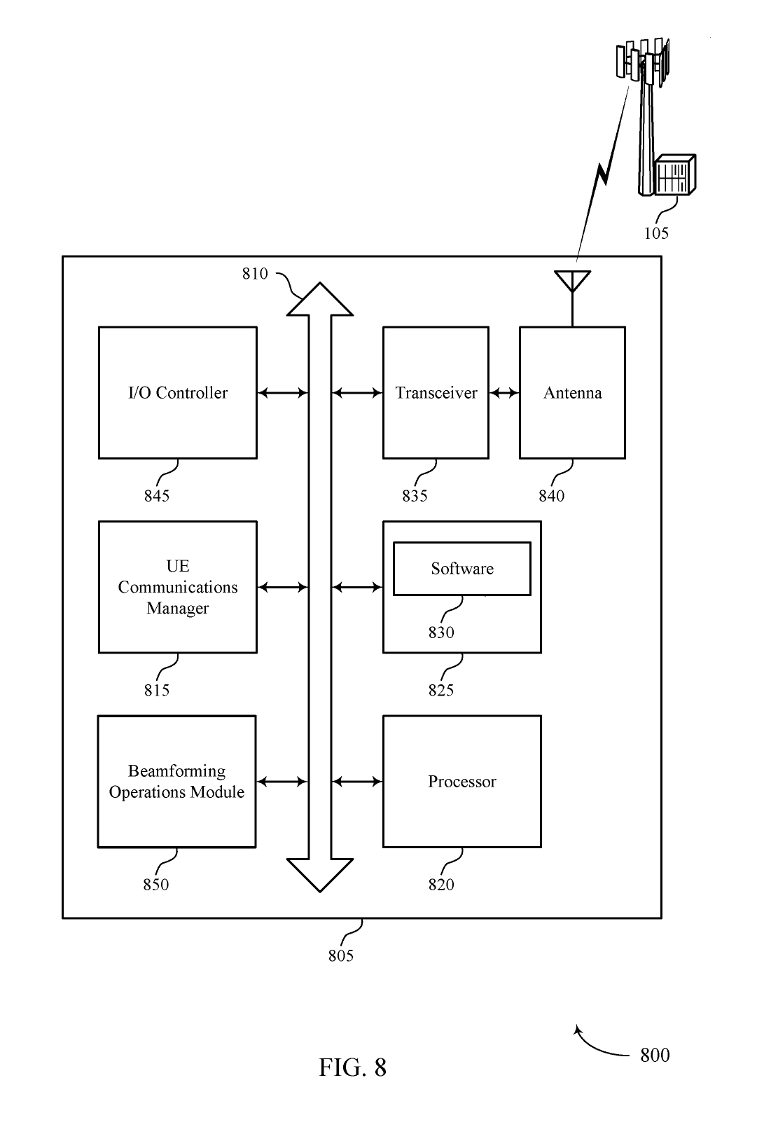

The receiver 510 may receive information such as packets, user data, or control information associated with various information channels (e.g., control channels, data channels, and information related to scheduling request transmission to request resources for a BSR, etc.). Information may be passed on to other components of the device. The receiver 510 may be an example of aspects of the transceiver 835 described with reference to FIG. 8.

The transmitter 520 may transmit signals received from other components of wireless device 505. In some examples, the transmitter 520 may be collocated with a receiver in a transceiver module. For example, the transmitter 520 may be an example of aspects of the transceiver 835 described with reference to FIG. 8. The transmitter 520 may include a single antenna, or it may include a plurality of antennas.

UE communications manager 515 may be an example of aspects of the UE communications manager 815 described with reference to FIG. 8.

UE communications manager 515 and/or at least some of its various sub-components may be implemented in hardware, software executed by a processor, firmware, or any combination thereof. If implemented in software executed by a processor, the functions of the UE communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. In some examples, the scheduling request may be transmitted using the transmission time, the set of subcarriers, the cyclic shift, the sequence index, or a combination thereof. The UE communications manager 515 and/or at least some of its various sub-components may be physically located at various positions, including being distributed such that portions of functions are implemented at different physical locations by one or more physical devices. In some examples, UE communications manager 515 and/or at least some of its various sub-components may be a separate and distinct component in accordance with various aspects of the present disclosure. In other examples, UE communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE communications manager 515 may receive a reference signal from a base station 105, identify a resource for transmitting a scheduling request to the base station 105, where the resource for transmitting the scheduling request is based on the reference signal, and transmit the scheduling request to the base station 105 using the resource. In some examples, UE communications manager 515 may identify a time period for transmitting a scheduling request and transmit a scheduling request to a base station 105 during the time period.

In some examples, the UE communications manager 515 may identify a resource from transmitting the scheduling request and transmit the scheduling request to the base station 105 using the resources. In some examples, the time period may be associated with a RACH In some examples, the UE communications manager 515 may receive a grant for transmitting a BSR in response to the scheduling request, and transmit the BSR to the base station 105 using resources indicated in the grant.

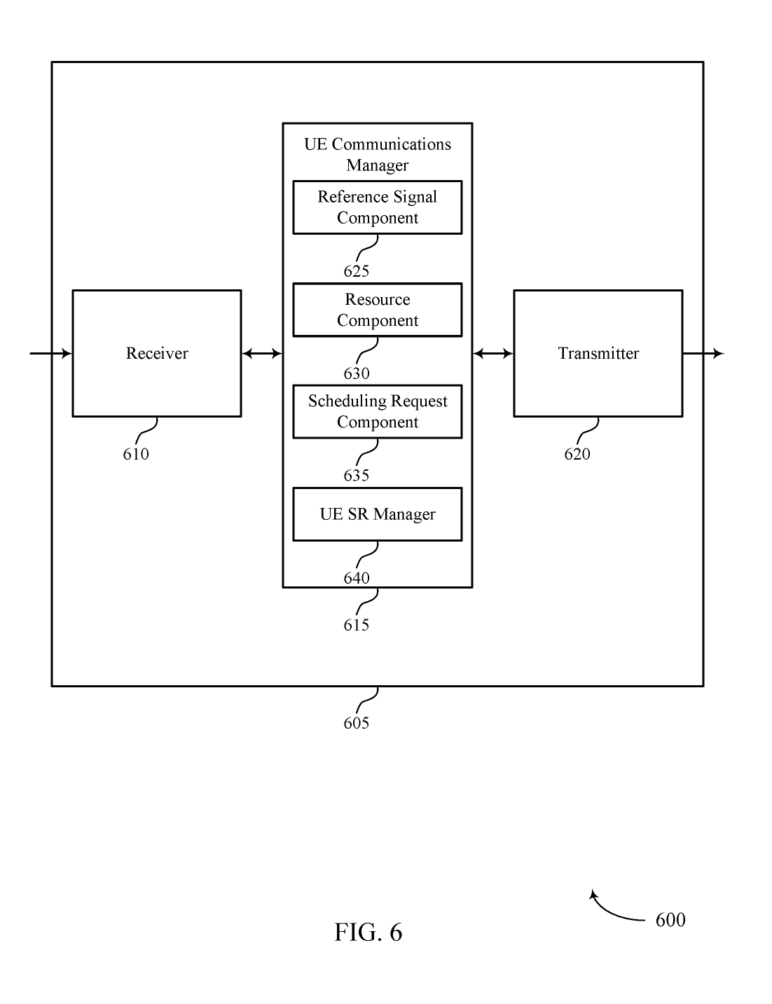

FIG. 6 shows a block diagram 600 of a wireless device 605 that supports scheduling request transmission to request resources for a BSR in accordance with various aspects of the present disclosure. Wireless device 605 may be an example of aspects of a wireless device 505 or a UE 115 as described with reference to FIGS. 1 and 5. wireless device 605 may include receiver 610, UE communications manager 615, and transmitter 620. wireless device 605 may also include a processor. Each of these components may be in communication with one another (e.g., via one or more buses).

Receiver 610 may receive information such as packets, user data, or control information associated with various information channels (e.g., control channels, data channels, and information related to scheduling request transmission to request resources for a BSR, etc.). Information may be passed on to other components of the device. The receiver 610 may be an example of aspects of the transceiver 835 described with reference to FIG. 8.

UE communications manager 615 may be an example of aspects of the UE communications manager 815 described with reference to FIG. 8.

UE communications manager 615 may also include reference signal component 625, resource component 630, scheduling request component 635, and UE SR manager 640.

Reference signal component 625 may receive a reference signal from a base station 105 and identify a reference signal from the set of reference signals, where the resource for transmitting the scheduling request is based on the reference signal from the set of reference signals. In some cases, the reference signal from the base station 105 includes one or more reference signals from a set of reference signals. In some cases, the reference signal from the set of reference signals is at least one of a PSS, an SSS, a DMRS for PBCH, a BRS, CSI-RS, an MRS, a CRS, or a combination thereof.

Resource component 630 may identify a resource for transmitting a scheduling request to the base station 105, where the resource for transmitting the scheduling request is based on the reference signal. In some examples, resource component 630 may identify resources for transmitting a scheduling request, such as a time period for transmitting the scheduling request. In some examples, the time period may be associated with a RACH. The resource component 630 may transmit a scheduling request to a base station 105 using the resources, for example during the time period. In some cases, the scheduling request includes a sequence repeated a set of times over a set of symbol periods.

Scheduling request component 635 may transmit the scheduling request to the base station 105 using the resource. In some cases, the scheduling request includes a sequence repeated a set of times over a set of symbol periods. In some cases, the scheduling request includes a short PUCCH format.

The UE SR manager 640 may identify a time period for transmitting a scheduling request and transmit a scheduling request to a base station 105 during the time period. In some examples, the UE SR manager 640 may identify a resource from transmitting the scheduling request and transmit the scheduling request to the base station 105 using the resources. In some examples, the time period may be associated with a RACH In some examples, the UE SR manager 640 may receive a grant for transmitting a BSR in response to the scheduling request, and transmit the BSR to the base station 105 using resources indicated in the grant.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may include a single antenna, or it may include a set of antennas.

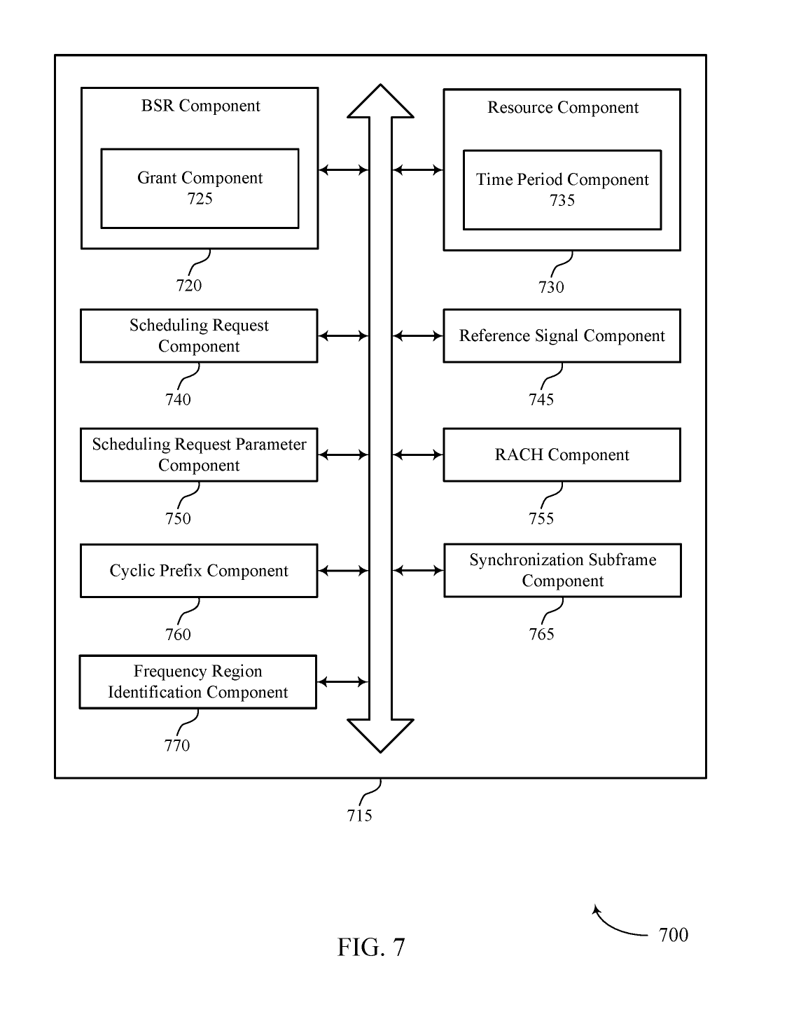

FIG. 7 shows a block diagram 700 of a UE communications manager 715 that supports scheduling request transmission to request resources for a BSR in accordance with various aspects of the present disclosure. The UE communications manager 715 may be an example of aspects of a UE communications manager 515, a UE communications manager 615, or a UE communications manager 815 described with reference to FIGS. 5, 6, and 8. The UE communications manager 715 may include BSR component 720, grant component 725, resource component 730, time period component 735, scheduling request component 740, reference signal component 745, scheduling request parameter component 750, RACH component 755, cyclic prefix component 760, synchronization subframe component 765, and frequency region identification component 770. Each of these modules may communicate, directly or indirectly, with one another (e.g., via one or more buses).

The BSR component 720 may include a grant component 725. In some implementations, the grant component 725 may receive a grant for transmitting a BSR in response to the scheduling request. In some cases, the resources indicated in the grant include PUSCH resources, PUCCH resources, or both. The BSR component 720 may transmit the BSR to the base station 105 using resources indicated in the grant.

Resource component 730 may identify a resource for transmitting a scheduling request to the base station 105, where the resource for transmitting the scheduling request is based on the reference signal. In some examples, resource component 730 include a time period component 735. Time period component 735 may identify a time period for transmitting a scheduling request. In some examples, the time period may be associated with a RACH.

Scheduling request component 740 may transmit the scheduling request to the base station 105 using the resource. In some cases, the scheduling request includes a sequence repeated a set of times over a set of symbol periods. In some cases, the scheduling request includes a short PUCCH format. In some examples, scheduling request component 740 may transmit the scheduling request to a base station 105 during the time period.

Reference signal component 745 may receive a reference signal from a base station 105 and identify a reference signal from the set of reference signals, where the resource for transmitting the scheduling request is based on the reference signal from the set of reference signals. In some cases, the reference signal from the base station 105 includes one or more reference signals from a set of reference signals. In some cases, the reference signal from the set of reference signals is at least one of a PSS, an SSS, a DMRS for PBCH, a BRS, CSI-RS, an MRS, a CRS, or a combination thereof.

Scheduling request parameter component 750 may determine, based on the resource, at least one of a transmission time, a set of subcarriers, a cyclic shift, or a sequence index, where the scheduling request is transmitted using the transmission time, the set of subcarriers, the cyclic shift, the sequence index, or a combination thereof and receive, from the base station 105, at least one of a transmission time, a set of subcarriers, a cyclic shift, a sequence index, where the scheduling request is transmitted using the transmission time, the set of subcarriers, the cyclic shift, the sequence index, or a combination thereof.

In some examples, scheduling request parameter component 750 may receive, from the base station 105, an indication of at least one of a cyclic shift, a set of subcarriers, or a sequence index from the base station 105, where the scheduling request is transmitted using the cyclic shift, the set of subcarriers, the sequence index, or a combination thereof. In some examples, the scheduling request parameter component 750 may also receive one or more of a system frame number, a BRS transmission period, a number of RACH subframes in a radio frame, an index of a current RACH subframe, or a symbol with the strongest synchronization beam.

RACH component 755 may identify a frequency region associated with the RACH and a frequency region associated with scheduling requests that does not overlap with the frequency region associated with the RACH, where the scheduling request is transmitted using resources located within the frequency region associated with scheduling requests. In some cases, the resource for transmitting the scheduling request is associated with a RACH.

Cyclic prefix component 760 may identify a cyclic prefix length for the scheduling request, where the cyclic prefix length includes a long cyclic prefix length associated with the RACH or a short cyclic prefix length associated with non-RACH transmissions.

Synchronization subframe component 765 may receive a directional synchronization subframe from the base station 105, where the time period for transmitting a scheduling request is identified based on the received directional synchronization subframe, and identify the directional synchronization subframe from a set of directional subframes transmitted by the base station 105 based on a signal strength of the directional synchronization subframe. The directional synchronization subframe may include a set of directional synchronization signals, and the time period may be based on identifying a directional signal from the set of directional synchronization signals. The directional synchronization signals may contain one or more combinations of a primary synchronization signal, a secondary synchronization signal, or a beam reference signal.

Frequency region identification component 770 may, in some examples, identify a frequency region associated with the RACH and a frequency region associated with scheduling requests that does not overlap with the frequency region associated with the RACH, where the scheduling request is transmitted using resources located within the frequency region associated with scheduling requests.

FIG. 8 shows a diagram of a system 800 including a device 805 that supports scheduling request transmission to request resources for a BSR in accordance with various aspects of the present disclosure. Device 805 may be an example of or include the components of wireless device 505, wireless device 605, or a UE 115 as described above, e.g., with reference to FIGS. 1, 5 and 6. Device 805 may include components for bi-directional voice and data communications including components for transmitting and receiving communications, including UE communications manager 815, processor 820, memory 825, software 830, transceiver 835, antenna 840, I/O controller 845, and beamforming operations module 850. UE communications manager 815 may be an example of aspects of a UE communications manager 515, a UE communications manager 615, or a UE communications manager 715 as described with reference to FIGS. 5-7. These components may be in electronic communication via one or more busses (e.g., bus 810). Device 805 may communicate wirelessly with one or more base stations 105.

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting scheduling request transmission to request resources for a BSR).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware and/or software operation such as the interaction with peripheral components or devices.

Software 830 may include code to implement aspects of the present disclosure, including code to support scheduling request transmission to request resources for a BSR. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/O controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system. In other cases, I/O controller 845 may represent or interact with a modem, a keyboard, a mouse, a touchscreen, or a similar device. In some cases, I/O controller 845 may be implemented as part of a processor. In some cases, a user may interact with device 805 via I/O controller 845 or via hardware components controlled by I/O controller 845.

Beamforming operations module 850 may enable the device 805 to send and receive transmissions using beamforming techniques (i.e., directional transmissions using an array of antennas).

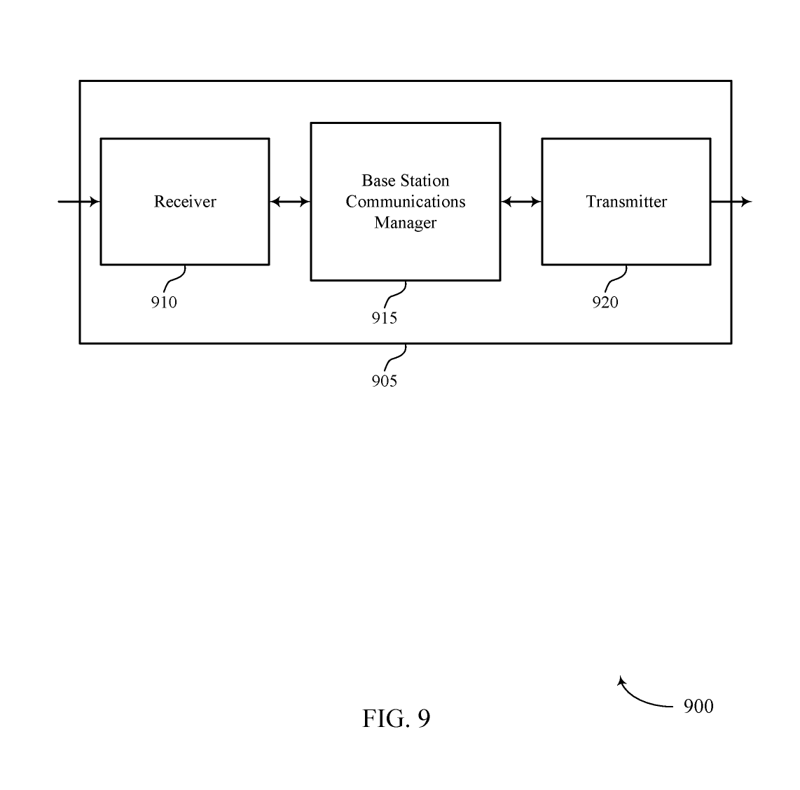

FIG. 9 shows a block diagram 900 of a wireless device 905 that supports scheduling request transmission to request resources for a BSR in accordance with various aspects of the present disclosure. Wireless device 905 may be an example of aspects of a base station 105 as described with reference to FIG. 1. wireless device 905 may include receiver 910, base station communications manager 915, and transmitter 920. wireless device 905 may also include a processor. Each of these components may be in communication with one another (e.g., via one or more buses).

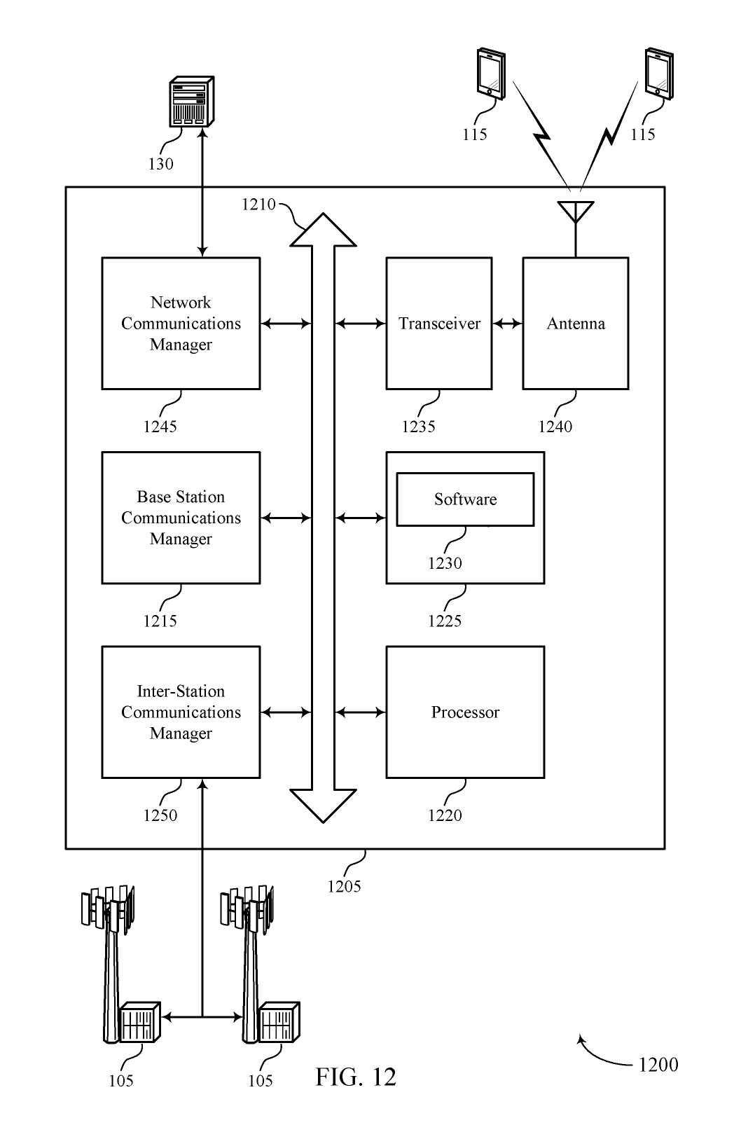

Receiver 910 may receive information such as packets, user data, or control information associated with various information channels (e.g., control channels, data channels, and information related to scheduling request transmission to request resources for a BSR, etc.). Information may be passed on to other components of the device. The receiver 910 may be an example of aspects of the transceiver 1235 described with reference to FIG. 12.

Base station communications manager 915 may be an example of aspects of the base station communications manager 1215 described with reference to FIG. 12.

Base station communications manager 915 and/or at least some of its various sub-components may be implemented in hardware, software executed by a processor, firmware, or any combination thereof. If implemented in software executed by a processor, the functions of the base station communications manager 915 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The base station communications manager 915 and/or at least some of its various sub-components may be physically located at various positions, including being distributed such that portions of functions are implemented at different physical locations by one or more physical devices. In some examples, base station communications manager 915 and/or at least some of its various sub-components may be a separate and distinct component in accordance with various aspects of the present disclosure. In other examples, base station communications manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Base station communications manager 915 may transmit a reference signal to a UE 115 and receive a scheduling request from the UE 115 using a resource selected by the UE 115 based on the reference signal. In other implementations, base station communications manager 915 may receive a scheduling request from a UE during a time period selected by the UE based at least in part on the directional synchronization subframe, transmit a grant for transmitting a BSR in response to the scheduling request, and receive the BSR from the UE using resources indicated in the grant. In some examples, the time period may be associated with a RACH.

Transmitter 920 may transmit signals generated by other components of the device. In some examples, the transmitter 920 may be collocated with a receiver 910 in a transceiver module. For example, the transmitter 920 may be an example of aspects of the transceiver 1235 described with reference to FIG. 12. The transmitter 920 may include a single antenna, or it may include a set of antennas.

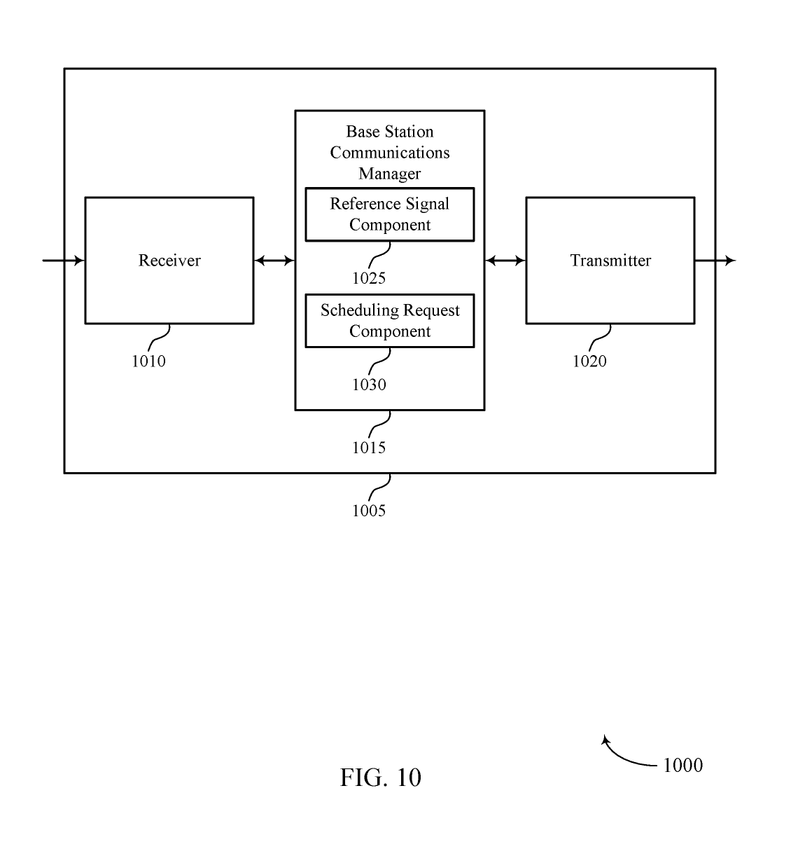

FIG. 10 shows a block diagram 1000 of a wireless device 1005 that supports scheduling request transmission to request resources for a BSR in accordance with various aspects of the present disclosure. Wireless device 1005 may be an example of aspects of a wireless device 905 or a base station 105 as described with reference to FIGS. 1 and 9. wireless device 1005 may include receiver 1010, base station communications manager 1015, and transmitter 1020. wireless device 1005 may also include a processor. Each of these components may be in communication with one another (e.g., via one or more buses).

Receiver 1010 may receive information such as packets, user data, or control information associated with various information channels (e.g., control channels, data channels, and information related to scheduling request transmission to request resources for a BSR, etc.). Information may be passed on to other components of the device. The receiver 1010 may be an example of aspects of the transceiver 1235 described with reference to FIG. 12.

Base station communications manager 1015 may be an example of aspects of the base station communications manager 1215 described with reference to FIG. 12. Base station communications manager 1015 may also include reference signal component 1025 and scheduling request component 1030. Reference signal component 1025 may transmit a reference signal to a UE 115. In some examples, base station communications manager 1015 may identify a time period for receiving a scheduling request selected by the UE 115 based on receiving a directional synchronization subframe. In some examples, the time period may be associated with a RACH. Base station communications manager 1015 may receive the scheduling request from the UE 115 during the time period. In some cases, the scheduling request includes a sequence repeated a set of times over a set of symbol periods.

Scheduling request component 1030 may receive a scheduling request from the UE 115 using a resource selected by the UE 115 based on the reference signal. In some cases, the scheduling request includes a sequence repeated a set of times over a set of symbol periods. In some examples, scheduling request component 1030 may transmit a grant for transmitting a BSR in response to the scheduling request. In some cases, the resources indicated in the grant includes PUSCH resources, PUCCH resources, or both. The scheduling request component 1030 may receive the BSR from the UE using resources indicated in the grant.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may include a single antenna, or it may include a set of antennas.

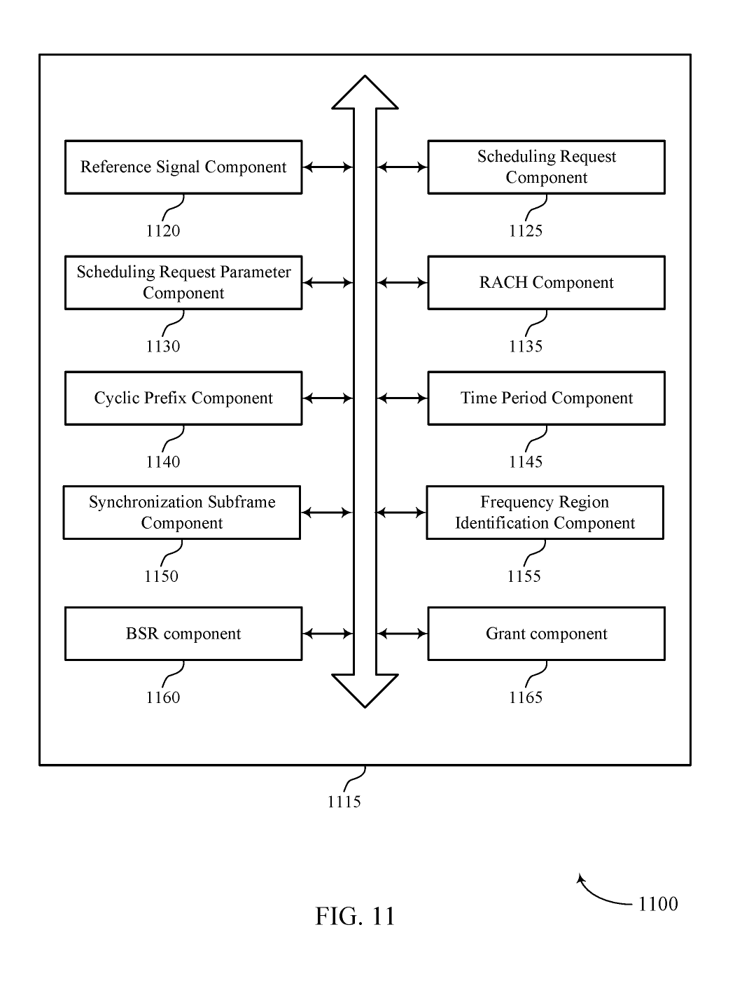

In some examples, the scheduling request component 1030 may include a time period component (e.g., a time period component 1145 from FIG. 11). The time period component may identify a time period for receiving a scheduling request selected by a UE 115 based on receiving a directional synchronization subframe. In some examples, the time period may be associated with a RACH. The scheduling request component 1030 may receive the scheduling request from the UE 115 during the time period. In some cases, the scheduling request includes a sequence repeated a set of times over a set of symbol periods.

FIG. 11 shows a block diagram 1100 of a base station communications manager 1115 that supports scheduling request transmission to request resources for a BSR in accordance with various aspects of the present disclosure. The base station communications manager 1115 may be an example of aspects of a base station communications manager 1215 described with reference to FIGS. 9, 10, and 12. The base station communications manager 1115 may include reference signal component 1120, scheduling request component 1125, scheduling request parameter component 1130, RACH component 1135, cyclic prefix component 1140, time period component 1145, synchronization subframe component 1150, frequency region identification component 1155, BSR component 1160, and grant component 1165. Each of these modules may communicate, directly or indirectly, with one another (e.g., via one or more buses).

Reference signal component 1120 may transmit a reference signal to a UE 115. Scheduling request component 1125 may receive a scheduling request from the UE 115 using a resource selected by the UE 115 based on the reference signal. In some cases, the scheduling request includes a sequence repeated a set of times over a set of symbol periods.

In other examples, scheduling request component 1125 may transmit a directional synchronization subframe to the UE 115 and identify a time period for receiving a scheduling request selected by the UE 115 based on the directional synchronization subframe. In some examples, the time period may be associated with a RACH. In some examples, scheduling request component 1125 may receive a scheduling request from the UE 115 during the time period.

Scheduling request parameter component 1130 may transmit an indication of at least one of a cyclic shift, a set of subcarriers, or a sequence index to the UE 115, where the scheduling request is received using the cyclic shift, the set of subcarriers, the sequence index, or combinations thereof.

RACH component 1135 may identify a frequency region associated with the RACH and a frequency region associated with scheduling requests that does not overlap with the frequency region associated with the RACH, where the scheduling request is received using resources located within the frequency region associated with scheduling requests. In some cases, the resource for receiving the scheduling request is associated with a RACH.

Cyclic prefix component 1140 may identify a cyclic prefix length for the scheduling request, where the cyclic prefix length includes a long cyclic prefix length associated with the RACH or a short cyclic prefix length associated with non-RACH transmissions.

The time period component 1145 may identify a time period for receiving a scheduling request selected by the UE 115 based on a directional synchronization subframe. In some examples, the time period may be associated with a RACH.

The synchronization subframe component 1150 may transmit a directional synchronization subframe to the UE 115, where the time period is associated with the directional synchronization subframe.

Frequency region identification component 1155 may identify a frequency region associated with the RACH and a frequency region associated with scheduling requests that does not overlap with the frequency region associated with the RACH, where the scheduling request is received using resources located within the frequency region associated with scheduling requests.

BSR component 1160 may transmit a grant for transmitting a BSR in response to the scheduling request and receive the BSR from the UE 115 using resources indicated in the grant. In some cases, the resources indicated in the grant includes PUSCH resources, PUCCH resources, or both. The BSR component 1160 may receive the BSR from the UE 115 using resources indicated in the grant. The grant component 1165 may transmit a grant for transmitting a BSR in response to the scheduling request. In some cases, the resources indicated in the grant includes PUSCH resources, PUCCH resources, or both.

FIG. 12 shows a diagram of a system 1200 including a device 1205 that supports scheduling request transmission to request resources for a BSR in accordance with various aspects of the present disclosure. Device 1205 may be an example of or include the components of base station 105 as described above, e.g., with reference to FIG. 1. Device 1205 may include components for bi-directional voice and data communications including components for transmitting and receiving communications, including base station communications manager 1215, processor 1220, memory 1225, software 1230, transceiver 1235, antenna 1240, network communications manager 1245, and inter-station communications manager 1250. These components may be in electronic communication via one or more busses (e.g., bus 1210). Device 1205 may communicate wirelessly with one or more UEs 115.

Base station communications manager 1215 may manage communications with other base station 105, and may include a controller or scheduler for controlling communications with UEs 115 in cooperation with other base stations 105. For example, the base station communications manager 1215 may coordinate scheduling for transmissions to UEs 115 for various interference mitigation techniques such as beamforming or joint transmission. In some examples, base station communications manager 1215 may provide an X2 interface within an Long Term Evolution (LTE)/LTE-A wireless communication network technology to provide communication between base stations 105. Base station communications manager 1215 may be an example of aspects of a base station communications manager 915, a base station communications manager 1015, or a base station communications manager 1115 as described with reference to FIGS. 9-11.

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting scheduling request transmission to request resources for a BSR).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware and/or software operation such as the interaction with peripheral components or devices.

Software 1230 may include code to implement aspects of the present disclosure, including code to support scheduling request transmission to request resources for a BSR. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

Network communications manager 1245 may manage communications with the core network (e.g., via one or more wired backhaul links). For example, the network communications manager 1245 may manage the transfer of data communications for client devices, such as one or more UEs 115.

Inter-station communications manager 1250 may manage communications with other base station 105, and may include a controller or scheduler for controlling communications with UEs 115 in cooperation with other base stations 105. For example, the inter-station communications manager 1250 may coordinate scheduling for transmissions to UEs 115 for various interference mitigation techniques such as beamforming or joint transmission. In some examples, inter-station communications manager 1250 may provide an X2 interface within an LTE/LTE-A wireless communication network technology to provide communication between base stations 105.

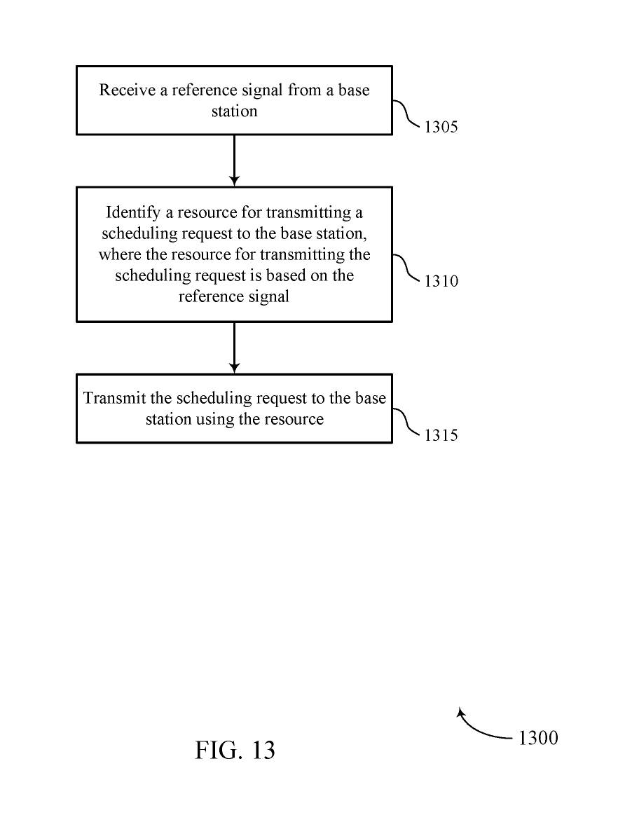

FIG. 13 shows a flowchart illustrating a method 1300 for scheduling request transmission to request resources for a BSR in accordance with various aspects of the present disclosure. The operations of method 1300 may be implemented by a UE 115 or its components as described herein. For example, the operations of method 1300 may be performed by a UE communications manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1305 the UE 115 may receive a reference signal from a base station. In some implementations, the UE 115 may receive a directional synchronization subframe from a base station 105. The operations of block 1305 may be performed according to the methods described with reference to FIGS. 1 through 4. In certain examples, aspects of the operations of block 1305 may be performed by a reference signal component as described with reference to FIGS. 5 through 8.

At block 1310 the UE 115 may identify a resource for transmitting a scheduling request to the base station 105, wherein the resource for transmitting the scheduling request is based at least in part on the reference signal. In some implementations, the UE 115 may identify a time period for transmitting a scheduling request, where the time period is based on the directional synchronization subframe. The operations of block 1310 may be performed according to the methods described with reference to FIGS. 1 through 4. In certain examples, aspects of the operations of block 1310 may be performed by a resource component as described with reference to FIGS. 5 through 8.

At block 1315 the UE 115 may transmit the scheduling request to the base station 105 using the resource. In some implementations, the UE 115 may transmit the scheduling request during the time period. The operations of block 1315 may be performed according to the methods described with reference to FIGS. 1 through 4. In certain examples, aspects of the operations of block 1315 may be performed by a scheduling request component as described with reference to FIGS. 5 through 8.

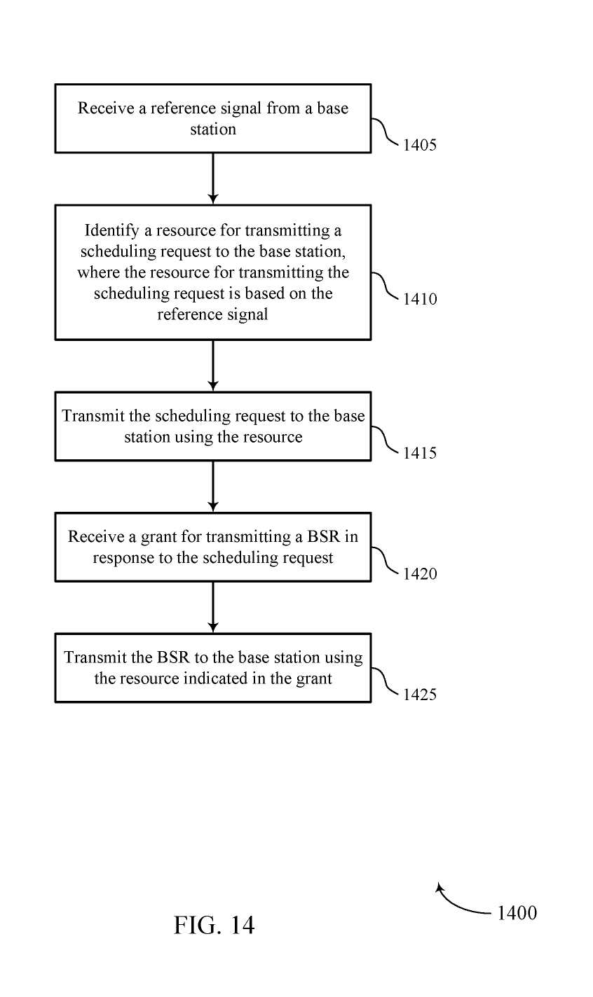

FIG. 14 shows a flowchart illustrating a method 1400 for scheduling request transmission to request resources for a BSR in accordance with various aspects of the present disclosure. The operations of method 1400 may be implemented by a UE 115 or its components as described herein. For example, the operations of method 1400 may be performed by a UE communications manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1405 the UE 115 may receive a reference signal from a base station 105. In some implementations, the UE 115 may receive a directional synchronization subframe from the base station 105 including a set of directional synchronization signals. In some examples, the UE 115 may identify a directional signal from the set of directional synchronization signals. The operations of block 1405 may be performed according to the methods described with reference to FIGS. 1 through 4. In certain examples, aspects of the operations of block 1405 may be performed by a reference signal component as described with reference to FIGS. 5 through 8.

At block 1410 the UE 115 may identify a resource for transmitting a scheduling request to the base station 105, wherein the resource for transmitting the scheduling request is based at least in part on the reference signal. In some implementations, the UE 115 may identify a time period for transmitting a scheduling request, where the time period for transmitting the scheduling request is based on the identified directional signal. The operations of block 1410 may be performed according to the methods described with reference to FIGS. 1 through 4. In certain examples, aspects of the operations of block 1410 may be performed by a resource component as described with reference to FIGS. 5 through 8.

At block 1415 the UE 115 may transmit the scheduling request to the base station 105 using the resource. In some implementations, the UE 115 may transmit the scheduling request to the base station 105 during the time period. The operations of block 1415 may be performed according to the methods described with reference to FIGS. 1 through 4. In certain examples, aspects of the operations of block 1415 may be performed by a scheduling request component as described with reference to FIGS. 5 through 8.

At block 1420 the UE 115 may receive a grant for transmitting a BSR in response to the scheduling request. The operations of block 1420 may be performed according to the methods described with reference to FIGS. 1 through 4. In certain examples, aspects of the operations of block 1420 may be performed by a BSR component as described with reference to FIGS. 5 through 8.

At block 1425 the UE 115 may transmit the BSR to the base station 105 using the resource indicated in the grant. The operations of block 1425 may be performed according to the methods described with reference to FIGS. 1 through 4. In certain examples, aspects of the operations of block 1425 may be performed by a BSR component as described with reference to FIGS. 5 through 8.

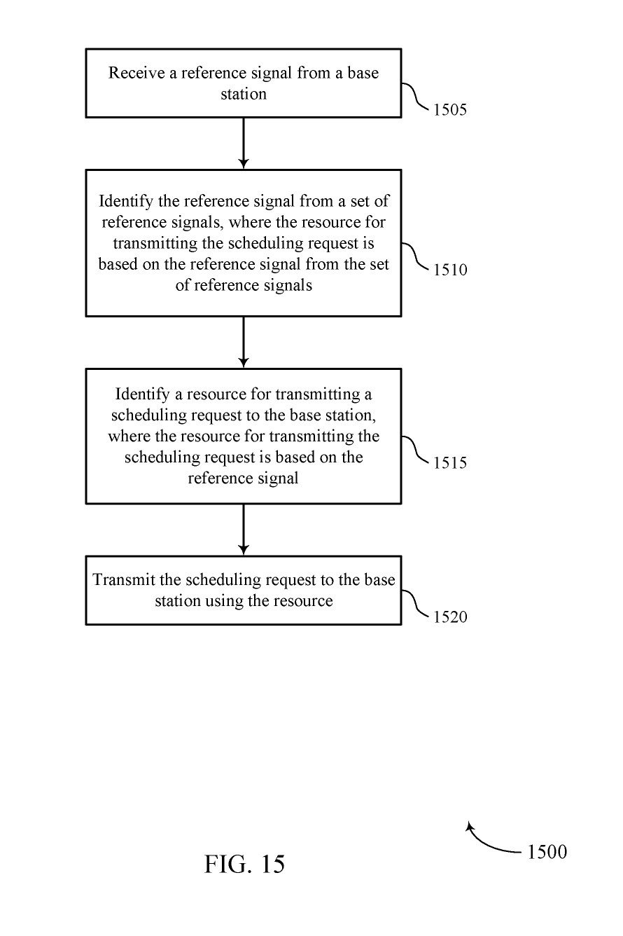

FIG. 15 shows a flowchart illustrating a method 1500 for scheduling request transmission to request resources for a BSR in accordance with various aspects of the present disclosure. The operations of method 1500 may be implemented by a UE 115 or its components as described herein. For example, the operations of method 1500 may be performed by a UE communications manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1505 the UE 115 may receive a reference signal from a base station 105. In some cases, the reference signal from the base station 105 comprises one or more reference signals from a set of reference signals. The operations of block 1505 may be performed according to the methods described with reference to FIGS. 1 through 4. In certain examples, aspects of the operations of block 1505 may be performed by a reference signal component as described with reference to FIGS. 5 through 8.

At block 1510 the UE 115 may identify the reference signal from a set of reference signals, where a resource for transmitting the scheduling request is based at least in part on the reference signal from the set of reference signals. The operations of block 1510 may be performed according to the methods described with reference to FIGS. 1 through 4. In certain examples, aspects of the operations of block 1510 may be performed by a reference signal component as described with reference to FIGS. 5 through 8.

At block 1515 the UE 115 may identify the resource for transmitting a scheduling request to the base station 105, where the resource for transmitting the scheduling request is based at least in part on the reference signal. The operations of block 1515 may be performed according to the methods described with reference to FIGS. 1 through 4. In certain examples, aspects of the operations of block 1515 may be performed by a resource component as described with reference to FIGS. 5 through 8.

At block 1520 the UE 115 may transmit the scheduling request to the base station 105 using the resource. In some examples, the resource for transmitting the scheduling request may be associated with a RACH. The operations of block 1520 may be performed according to the methods described with reference to FIGS. 1 through 4. In certain examples, aspects of the operations of block 1520 may be performed by a scheduling request component as described with reference to FIGS. 5 through 8.

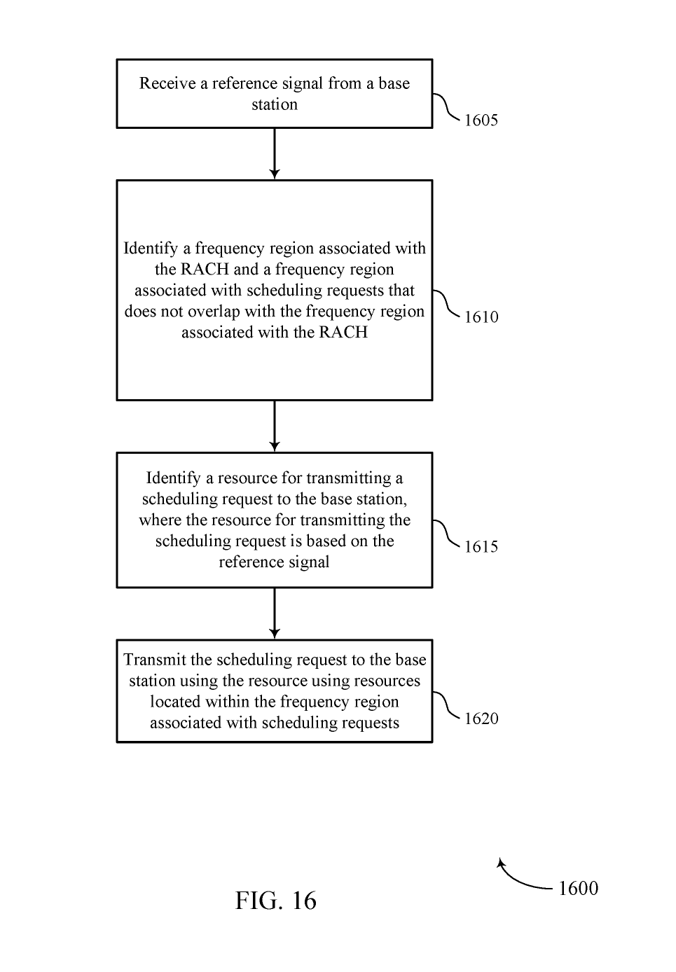

FIG. 16 shows a flowchart illustrating a method 1600 for scheduling request transmission to request resources for a BSR in accordance with various aspects of the present disclosure. The operations of method 1600 may be implemented by a UE 115 or its components as described herein. For example, the operations of method 1600 may be performed by a UE communications manager as described with reference to FIGS. 5 through 8. In some examples, a UE 115 may execute a set of codes to control the functional elements of the device to perform the functions described below. Additionally or alternatively, the UE 115 may perform aspects of the functions described below using special-purpose hardware.

At block 1605 the UE 115 may receive a reference signal from a base station 105. The operations of block 1605 may be performed according to the methods described with reference to FIGS. 1 through 4. In certain examples, aspects of the operations of block 1605 may be performed by a reference signal component as described with reference to FIGS. 5 through 8.

At block 1610 the UE 115 may identify a frequency region associated with the RACH and a frequency region associated with scheduling requests that does not overlap with the frequency region associated with the RACH, wherein the scheduling request is transmitted using resources located within the frequency region associated with scheduling requests. In some implementations, the UE 115 may identify a time period for transmitting a scheduling request, where the time period is associated with the RACH. In some examples, the UE 115 may identify a cyclic prefix length for the scheduling request, where the cyclic prefix length includes a long cyclic prefix length associated with the RACH or a short cyclic prefix length associated with non-RACH transmissions. The operations of block 1610 may be performed according to the methods described with reference to FIGS. 1 through 4. In certain examples, aspects of the operations of block 1610 may be performed by a RACH component as described with reference to FIGS. 5 through 8.

At block 1615 the UE 115 may identify a resource for transmitting a scheduling request to the base station 105, wherein the resource for transmitting the scheduling request is based at least in part on the reference signal. The operations of block 1615 may be performed according to the methods described with reference to FIGS. 1 through 4. In certain examples, aspects of the operations of block 1615 may be performed by a resource component as described with reference to FIGS. 5 through 8.

At block 1620 the UE 115 may transmit the scheduling request to the base station 105 using resources located within the frequency region associated with scheduling requests. In some implementations, the UE 115 may receive a grant for transmitting a BSR in response to the scheduling request and transmit the BS Rot the base station 105 using resources indicated in the grant. The operations of block 1620 may be performed according to the methods described with reference to FIGS. 1 through 4. In certain examples, aspects of the operations of block 1620 may be performed by a scheduling request component as described with reference to FIGS. 5 through 8.

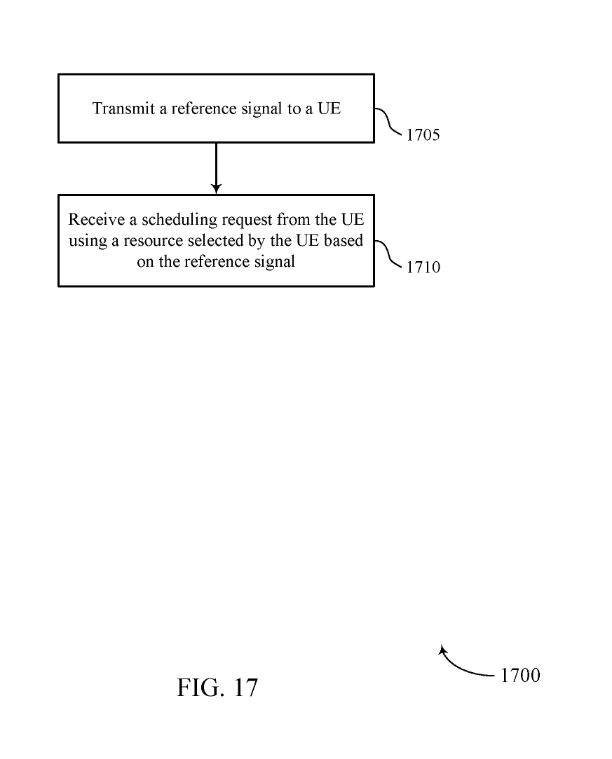

FIG. 17 shows a flowchart illustrating a method 1700 for scheduling request transmission to request resources for a BSR in accordance with various aspects of the present disclosure. The operations of method 1700 may be implemented by a base station 105 or its components as described herein. For example, the operations of method 1700 may be performed by a base station communications manager as described with reference to FIGS. 9 through 12. In some examples, a base station 105 may execute a set of codes to control the functional elements of the device to perform the functions described below. Additionally or alternatively, the base station 105 may perform aspects of the functions described below using special-purpose hardware.

At block 1705 the base station 105 may transmit a reference signal to a UE 115. In some implementations, the base station 105 may transmit a directional synchronization subframe to the UE 115. The operations of block 1705 may be performed according to the methods described with reference to FIGS. 1 through 4. In certain examples, aspects of the operations of block 1705 may be performed by a reference signal component as described with reference to FIGS. 9 through 12.

At block 1710 the base station 105 may receive a scheduling request from the UE using a resource selected by the UE based at least in part on the reference signal. In some implementations, the base station 105 may receive a scheduling request from the UE 115 during a time period selected by the UE 115 based on the directional synchronization subframe. The operations of block 1710 may be performed according to the methods described with reference to FIGS. 1 through 4. In certain examples, aspects of the operations of block 1710 may be performed by a scheduling request component as described with reference to FIGS. 9 through 12.

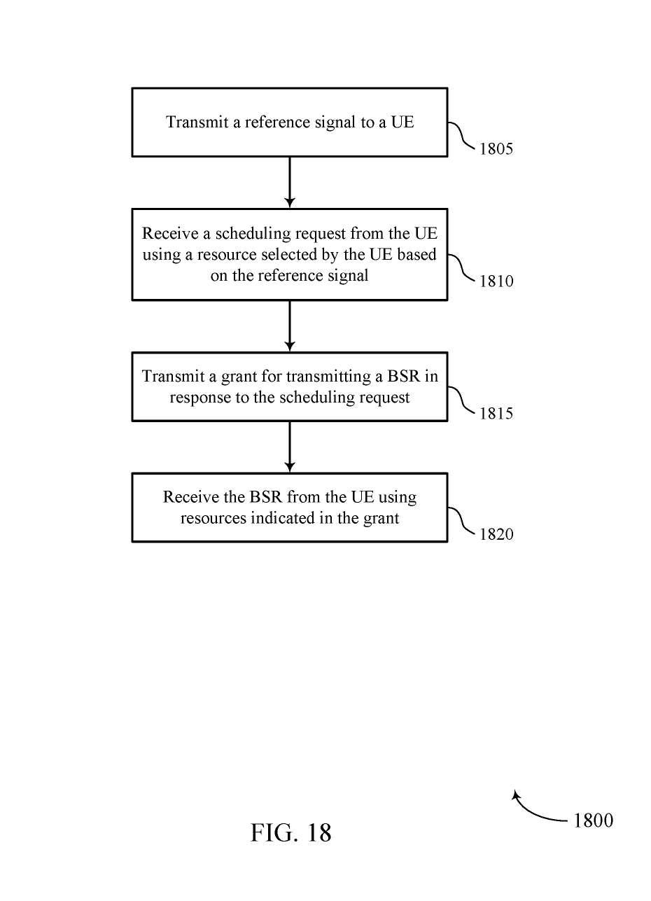

FIG. 18 shows a flowchart illustrating a method 1800 for scheduling request transmission to request resources for a BSR in accordance with various aspects of the present disclosure. The operations of method 1800 may be implemented by a base station 105 or its components as described herein. For example, the operations of method 1800 may be performed by a base station communications manager as described with reference to FIGS. 9 through 12. In some examples, a base station 105 may execute a set of codes to control the functional elements of the device to perform the functions described below. Additionally or alternatively, the base station 105 may perform aspects of the functions described below using special-purpose hardware.

At block 1805 the base station 105 may transmit a reference signal to a UE 115. In some implementations, the base station 105 may transmit a directional synchronization subframe to the UE 115. The operations of block 1805 may be performed according to the methods described with reference to FIGS. 1 through 4. In certain examples, aspects of the operations of block 1805 may be performed by a reference signal component as described with reference to FIGS. 9 through 12.

At block 1810 the base station 105 may receive a scheduling request from the UE using a resource selected by the UE based at least in part on the reference signal. In some implementations, the base station 105 may receive a scheduling request from the UE 115 during a time period selected by the UE 115 based on the directional synchronization subframe. The operations of block 1810 may be performed according to the methods described with reference to FIGS. 1 through 4. In certain examples, aspects of the operations of block 1810 may be performed by a scheduling request component as described with reference to FIGS. 9 through 12.

At block 1815 the base station 105 may transmit a grant for transmitting a BSR in response to the scheduling request. The operations of block 1815 may be performed according to the methods described with reference to FIGS. 1 through 4. In certain examples, aspects of the operations of block 1815 may be performed by a BSR component as described with reference to FIGS. 9 through 12.

At block 1820 the base station 105 may receive the BSR from the UE 115 using resources indicated in the grant. The operations of block 1820 may be performed according to the methods described with reference to FIGS. 1 through 4. In certain examples, aspects of the operations of block 1820 may be performed by a BSR component as described with reference to FIGS. 9 through 12.

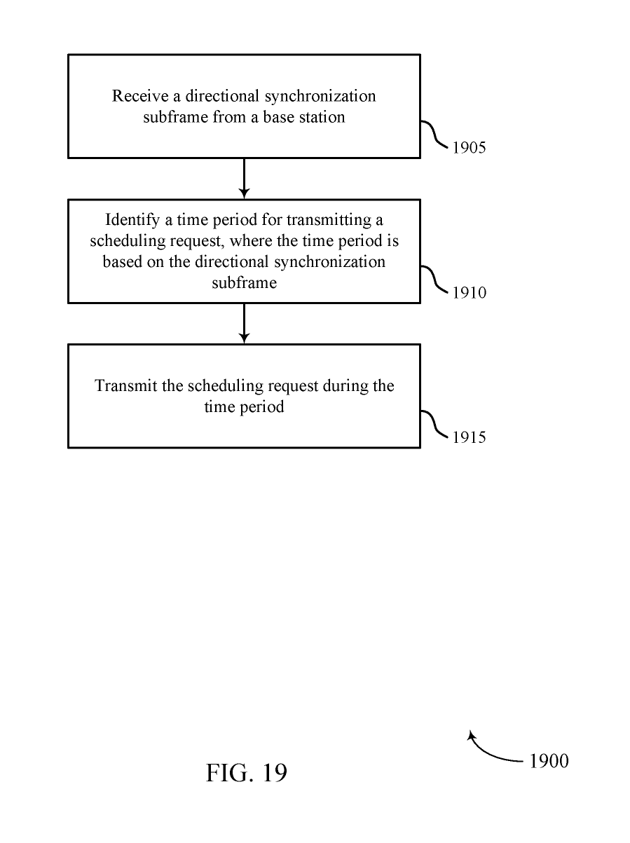

FIG. 19 shows a flowchart illustrating a method 1900 for scheduling request transmission based on a directional synchronization subframe in accordance with various aspects of the present disclosure. The operations of method 1900 may be implemented by a device such as a UE 115 or its components as described with reference to FIGS. 1 and 2. For example, the operations of method 1900 may be performed by the UE SR manager or UE communication manager as described herein. In some examples, the UE 115 may execute a set of codes to control the functional elements of the device to perform the functions described below. Additionally or alternatively, the UE 115 may perform aspects the functions described below using special-purpose hardware.

At block 1905, the UE 115 may receive a directional synchronization subframe from a base station 105 as described above with reference to FIGS. 2 through 4. In certain examples, the operations of block 1905 may be performed by the synchronization subframe component as described with reference to FIG. 7.

At block 1910, the UE 115 may identify a time period for transmitting a scheduling request as described above with reference to FIGS. 2 through 4. In certain examples, the operations of block 1910 may be performed by the time period component as described with reference to FIG. 7.

At block 1915, the UE 115 may transmit a scheduling request to a base station 105 during the time period as described above with reference to FIGS. 2 through 4. In certain examples, the operations of block 1915 may be performed by the scheduling request component as described with reference to FIGS. 6 and 7.

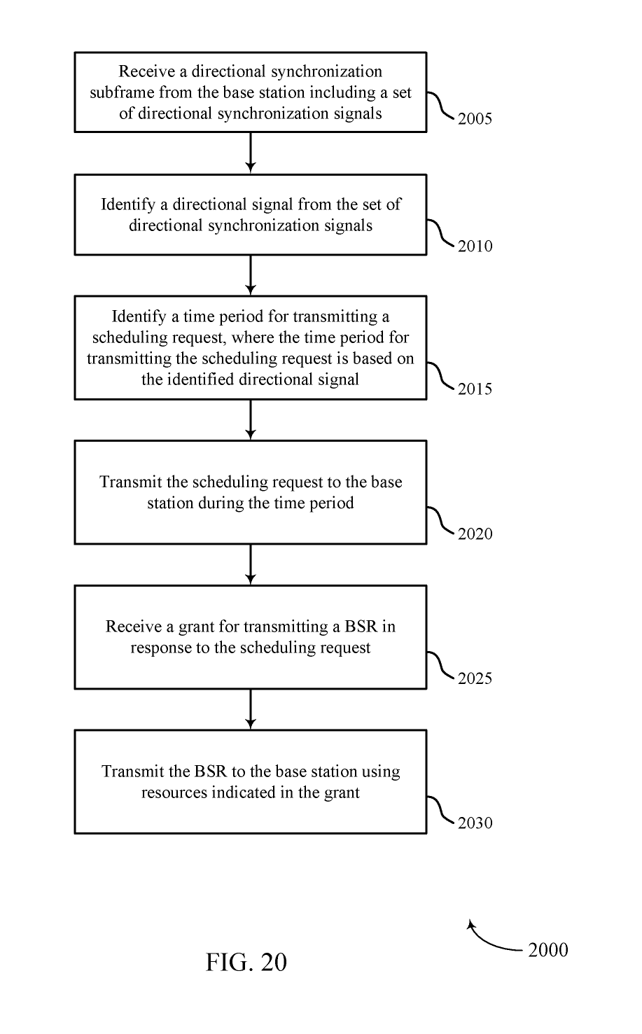

FIG. 20 shows a flowchart illustrating a method 2000 for scheduling request transmission to request resources for a BSR in accordance with various aspects of the present disclosure. The operations of method 2000 may be implemented by a device such as a UE 115 or its components as described with reference to FIGS. 1 and 2. For example, the operations of method 2000 may be performed by the UE communication manager or the UE SR manager as described herein. In some examples, the UE 115 may execute a set of codes to control the functional elements of the device to perform the functions described below. Additionally or alternatively, the UE 115 may perform aspects the functions described below using special-purpose hardware.

At block 2005, the UE 115 may receive a directional synchronization subframe from the base station 105 as described above with reference to FIGS. 2 through 4. In some examples, the directional synchronization subframe may include a set of directional synchronization signals. In certain examples, the operations of block 2005 may be performed by the synchronization subframe component as described with reference to FIG. 7.

At block 2010, the UE 115 may identify a directional signal from the set of directional synchronization signals as described above with reference to FIGS. 2 through 4. In certain examples, the operations of block 2010 may be performed by the synchronization subframe component as described with reference to FIG. 7.

At block 2015, the UE 115 may identify a time period for transmitting a scheduling request, where the time period for transmitting the scheduling request is based on the identified directional signal as described above with reference to FIGS. 2 through 4. In certain examples, the operations of block 2015 may be performed by the time period component as described with reference to FIG. 7.

At block 2020, the UE 115 may transmit a scheduling request to a base station 105 during the time period for transmitting the scheduling request as described above with reference to FIGS. 2 through 4. In certain examples, the operations of block 2020 may be performed by the scheduling request component as described with reference to FIGS. 6 and 7.

At block 2025, the UE 115 may receive a grant for transmitting a BSR in response to the scheduling request as described above with reference to FIGS. 2 through 4. In certain examples, the operations of block 2025 may be performed by the grant component as described with reference to FIG. 7.

At block 2030, the UE 115 may transmit the BSR to the base station 105 using resources indicated in the grant as described above with reference to FIGS. 2 through 4. In certain examples, the operations of block 2030 may be performed by the BSR component as described with reference to FIG. 7.

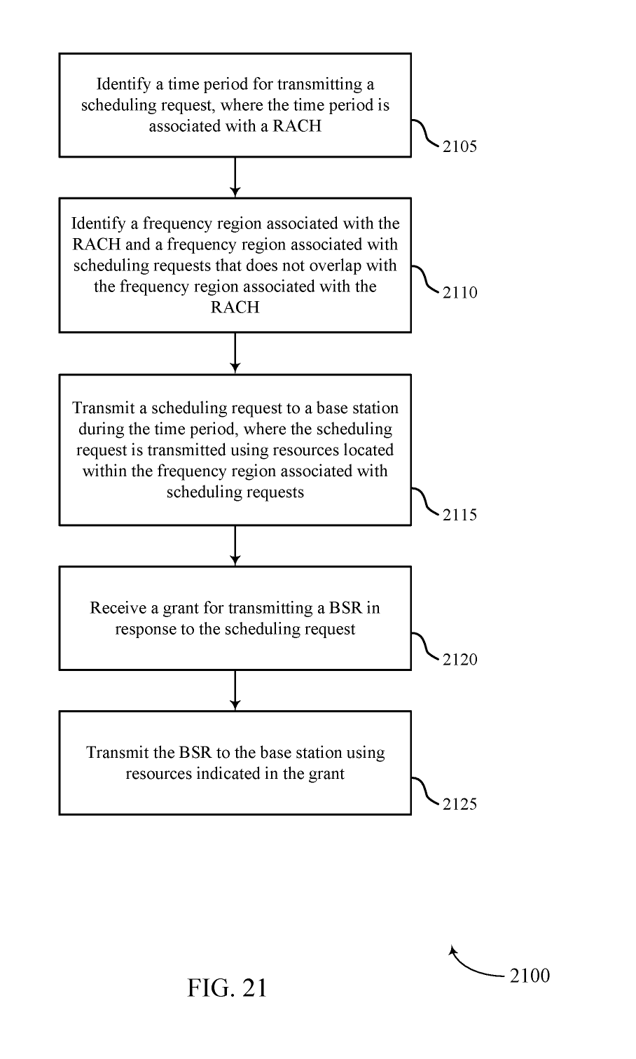

FIG. 21 shows a flowchart illustrating a method 2100 for scheduling request transmission to request resources for a BSR in accordance with various aspects of the present disclosure. The operations of method 2100 may be implemented by a device such as a UE 115 or its components as described with reference to FIGS. 1 and 2. For example, the operations of method 2100 may be performed by the UE communication manager or the UE SR manager as described herein. In some examples, the UE 115 may execute a set of codes to control the functional elements of the device to perform the functions described below. Additionally or alternatively, the UE 115 may perform aspects the functions described below using special-purpose hardware.

At block 2105, the UE 115 may identify a time period for transmitting a scheduling request, where the time period is associated with a RACH as described above with reference to FIGS. 2 through 4. In certain examples, the operations of block 2105 may be performed by the time period component as described with reference to FIG. 7.

At block 2110, the UE 115 may identify a frequency region associated with the RACH and a frequency region associated with scheduling requests that does not overlap with the frequency region associated with the RACH as described above with reference to FIGS. 2 through 4. In certain examples, the operations of block 2110 may be performed by the frequency region identification component as described with reference to FIG. 7.

At block 2115, the UE 115 may transmit a scheduling request to a base station 105 during the time period, where the scheduling request is transmitted using resources located within the frequency region associated with scheduling requests as described above with reference to FIGS. 2 through 4. In certain examples, the operations of block 2115 may be performed by the scheduling request component as described with reference to FIGS. 6 and 7.

At block 2120, the UE 115 may receive a grant for transmitting a BSR in response to the scheduling request as described above with reference to FIGS. 2 through 4. In certain examples, the operations of block 2120 may be performed by the grant component as described with reference to FIG. 7.

At block 2125, the UE 115 may transmit the BSR to the base station 105 using resources indicated in the grant as described above with reference to FIGS. 2 through 4. In certain examples, the operations of block 2125 may be performed by the BSR component as described with reference to FIG. 7.

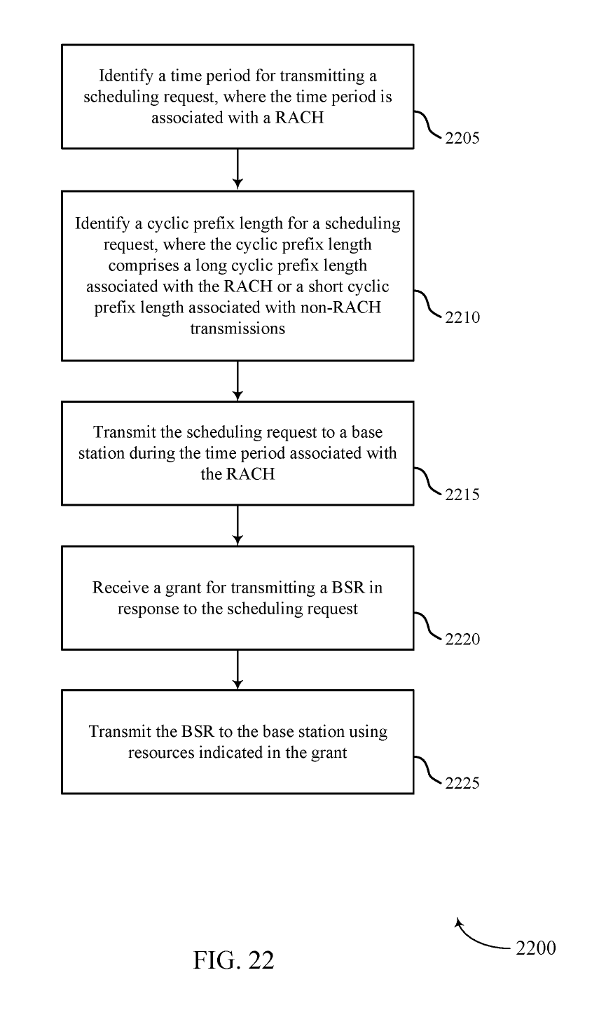

FIG. 22 shows a flowchart illustrating a method 2200 for scheduling request transmission to request resources for a BSR in accordance with various aspects of the present disclosure. The operations of method 2200 may be implemented by a device such as a UE 115 or its components as described with reference to FIGS. 1 and 2. For example, the operations of method 2200 may be performed by the UE communications manager or UE SR manager as described herein. In some examples, the UE 115 may execute a set of codes to control the functional elements of the device to perform the functions described below. Additionally or alternatively, the UE 115 may perform aspects the functions described below using special-purpose hardware.

At block 2205, the UE 115 may identify a time period for transmitting a scheduling request, where the time period is associated with a RACH as described above with reference to FIGS. 2 through 4. In certain examples, the operations of block 2205 may be performed by the time period component as described with reference to FIG. 7.

At block 2210, the UE 115 may identify a cyclic prefix length for a scheduling request, where the cyclic prefix length includes a long cyclic prefix length associated with the RACH or a short cyclic prefix length associated with non-RACH transmissions as described above with reference to FIGS. 2 through 4. In certain examples, the operations of block 2210 may be performed by the cyclic prefix component as described with reference to FIG. 7.

At block 2215, the UE 115 may transmit the scheduling request to a base station 105 during the time period as described above with reference to FIGS. 2 through 4. In certain examples, the operations of block 2215 may be performed by the scheduling request component as described with reference to FIGS. 6 and 7.

At block 2220, the UE 115 may receive a grant for transmitting a BSR in response to the scheduling request as described above with reference to FIGS. 2 through 4. In certain examples, the operations of block 2220 may be performed by the grant component as described with reference to FIG. 7.

At block 2225, the UE 115 may transmit the BSR to the base station 105 using resources indicated in the grant as described above with reference to FIGS. 2 through 4. In certain examples, the operations of block 2225 may be performed by the BSR component as described with reference to FIG. 7.

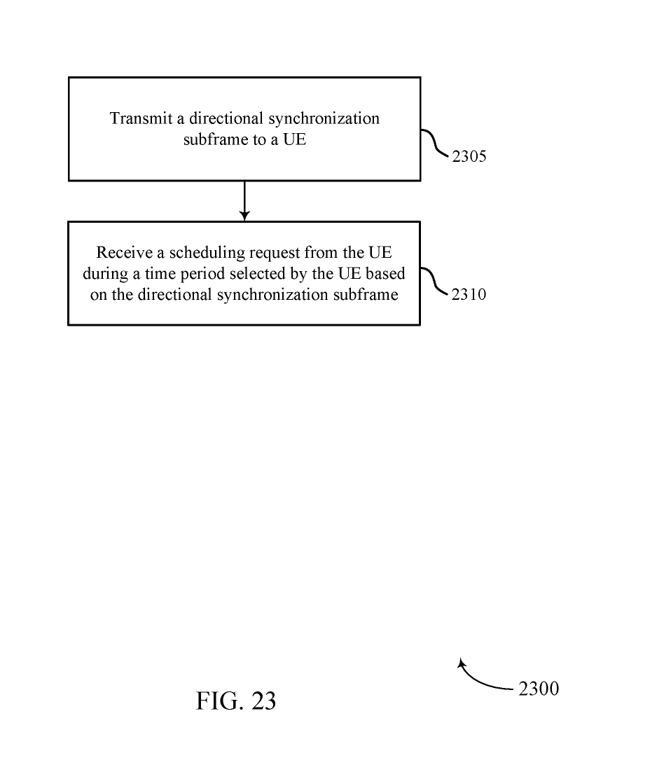

FIG. 23 shows a flowchart illustrating a method 2300 for scheduling request transmission to request resources for a BSR in accordance with various aspects of the present disclosure. The operations of method 2300 may be implemented by a device such as a base station 105 or its components as described with reference to FIGS. 1 and 2. For example, the operations of method 2300 may be performed by the base station communications manager or the base station SR manager as described herein. In some examples, the base station 105 may execute a set of codes to control the functional elements of the device to perform the functions described below. Additionally or alternatively, the base station 105 may perform aspects the functions described below using special-purpose hardware.

At block 2305, the base station 105 may transmit a directional synchronization subframe to a UE 115 as described above with reference to FIGS. 2 through 4. In certain examples, the operations of block 2305 may be performed by the synchronization subframe component as described with reference to FIG. 11

At block 2310, the base station 105 may receive a scheduling request from the UE during a time period selected by the UE 115 based on the directional synchronization subframe as described above with reference to FIGS. 2 through 4. In certain examples, the operations of block 2310 may be performed by the scheduling request component as described with reference to FIGS. 10 and 11.

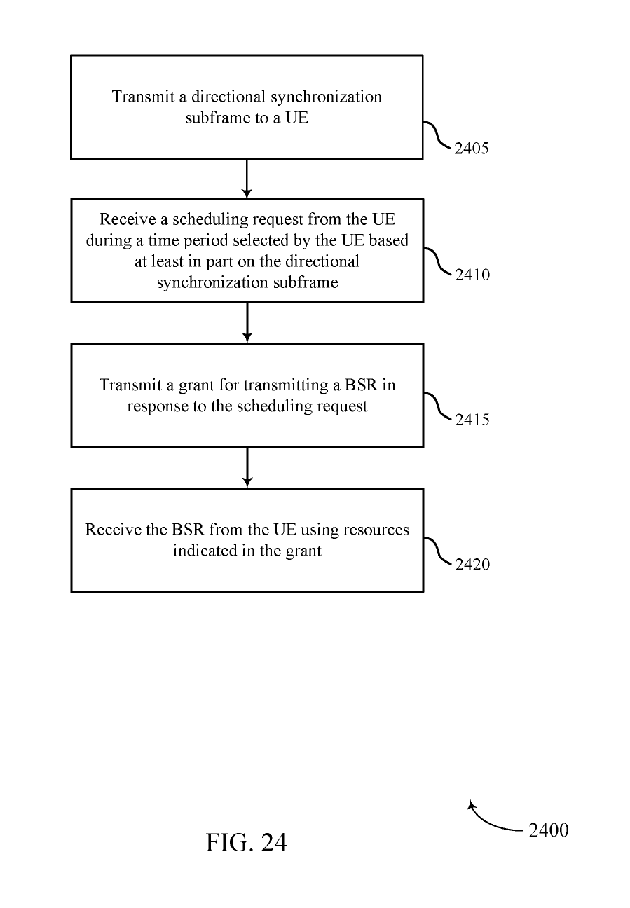

FIG. 24 shows a flowchart illustrating a method 2400 for scheduling request transmission to request resources for a BSR in accordance with various aspects of the present disclosure. The operations of method 2400 may be implemented by a device such as a base station 105 or its components as described with reference to FIGS. 1 and 2. For example, the operations of method 2400 may be performed by the base station SR manager as described herein. In some examples, the base station 105 may execute a set of codes to control the functional elements of the device to perform the functions described below. Additionally or alternatively, the base station 105 may perform aspects the functions described below using special-purpose hardware.

At block 2405, the base station 105 may transmit a directional synchronization subframe to a UE 115 as described above with reference to FIGS. 2 through 4. In certain examples, the operations of block 2405 may be performed by the synchronization subframe component as described with reference to FIG. 11

At block 2410, the base station 105 may receive a scheduling request from a UE 115 during the time period as described above with reference to FIGS. 2 through 4. In certain examples, the operations of block 2410 may be performed by the scheduling request component as described with reference to FIGS. 10 and 11.

At block 2415, the base station 105 may transmit a grant for transmitting a BSR in response to the scheduling request as described above with reference to FIGS. 2 through 4. In certain examples, the operations of block 2415 may be performed by the grant component as described with reference to FIG. 11.

At block 2420, the base station 105 may receive the BSR from the UE 115 using resources indicated in the grant as described above with reference to FIGS. 2 through 4. In certain examples, the operations of block 2420 may be performed by the BSR component as described with reference to FIG. 11.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are releases of Universal Mobile Telecommunications System (UMTS) that use E-UTRA. UTRA, E-UTRA, UMTS, LTE, LTE-A, NR, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of evolved node B (eNBs) provide coverage for various geographical regions. For example, each eNB, gNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), next generation NodeB (gNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving a reference signal from a base station;
identifying a resource for transmitting a scheduling request to the base station, wherein the resource for transmitting the scheduling request is based at least in part on the reference signal; and
transmitting the scheduling request to the base station using the resource.

2. The method of claim 1, further comprising:
receiving a grant for transmitting a buffer status report (BSR) in response to the scheduling request; and
transmitting the BSR to the base station using the resource indicated in the grant.

3. The method of claim 2, wherein:
the resource indicated in the grant comprise physical uplink shared channel (PUSCH) resources, physical uplink control channel (PUCCH) resources, or both.

4. The method of claim 1, wherein:
the reference signal from the base station comprises one or more reference signals from a set of reference signals.

5. The method of claim 4, further comprising:
identifying a reference signal from the set of reference signals, wherein the resource for transmitting the scheduling request is based at least in part on the reference signal from the set of reference signals.

6. The method of claim 4, wherein:
the reference signal from the set of reference signals is at least one of a primary synchronization signal (PSS), a secondary synchronization signal (SSS), a demodulation reference signal (DMRS) for a physical broadcast channel (PBCH), a beam reference signal (BRS), channel state indicator reference signal (CSI-RS), a mobility reference signal (MRS), a cell specific reference signal (CRS), or a combination thereof.

7. The method of claim 1, further comprising:
determining, based at least in part on the resource, at least one of a transmission time, a set of subcarriers, a cyclic shift, or a sequence index, wherein the scheduling request is transmitted using the transmission time, the set of subcarriers, the cyclic shift, the sequence index, or a combination thereof.

8. The method of claim 1, further comprising:
receiving, from the base station, at least one of a transmission time, a set of subcarriers, a cyclic shift, a sequence index, wherein the scheduling request is transmitted using the transmission time, the set of subcarriers, the cyclic shift, the sequence index, or a combination thereof.

9. The method of claim 1, wherein:
the scheduling request comprises a sequence repeated a plurality of times over a plurality of symbol periods.

10. The method of claim 1, wherein:
the scheduling request comprises a short PUCCH format.

11. The method of claim 1, wherein:
the resource for transmitting the scheduling request is associated with a random access channel (RACH).

12. The method of claim 11, further comprising:
identifying a frequency region associated with the RACH and a frequency region associated with scheduling requests that does not overlap with the frequency region associated with the RACH, wherein the scheduling request is transmitted using resources located within the frequency region associated with scheduling requests.

13. The method of claim 11, further comprising:
identifying a cyclic prefix length for the scheduling request, wherein the cyclic prefix length comprises a long cyclic prefix length associated with the RACH or a short cyclic prefix length associated with non-RACH transmissions.

14. A method for wireless communication, comprising:
transmitting a reference signal to a user equipment (UE); and
receiving a scheduling request from the UE using a resource selected by the UE based at least in part on the reference signal.

15. The method of claim 14, further comprising:
transmitting a grant for transmitting a buffer status report (BSR) in response to the scheduling request; and
receiving the BSR from the UE using resources indicated in the grant.

16. The method of claim 15, wherein:
the resources indicated in the grant comprises physical uplink shared channel (PUSCH) resources, physical uplink control channel (PUCCH) resources, or both.

17. The method of claim 14, wherein:
the resource for receiving the scheduling request is associated with a random access channel (RACH).

18. The method of claim 17, further comprising:
identifying a frequency region associated with the RACH and a frequency region associated with scheduling requests that does not overlap with the frequency region associated with the RACH, wherein the scheduling request is received using resources located within the frequency region associated with scheduling requests.

19. The method of claim 17, further comprising:
identifying a cyclic prefix length for the scheduling request, wherein the cyclic prefix length comprises a long cyclic prefix length associated with the RACH or a short cyclic prefix length associated with non-RACH transmissions.

20. The method of claim 14, further comprising:
transmitting an indication of at least one of a cyclic shift, a set of subcarriers, or a sequence index to the UE, wherein the scheduling request is received using the cyclic shift, the set of subcarriers, the sequence index, or combinations thereof.

21. The method of claim 14, wherein:
the scheduling request comprises a sequence repeated a plurality of times over a plurality of symbol periods.

22. An apparatus for wireless communication, comprising:
means for receiving a reference signal from a base station;
means for identifying a resource for transmitting a scheduling request to the base station, wherein the resource for transmitting the scheduling request is based at least in part on the reference signal; and
means for transmitting the scheduling request to the base station using the resource.

23. The apparatus of claim 22, further comprising:
means for receiving a grant for transmitting a buffer status report (BSR) in response to the scheduling request; and
means for transmitting the BSR to the base station using the resource indicated in the grant.

24. The apparatus of claim 23, wherein:
the resource indicated in the grant comprise physical uplink shared channel (PUSCH) resources, physical uplink control channel (PUCCH) resources, or both.

25. The apparatus of claim 22, wherein:
the reference signal from the base station comprises one or more reference signals from a set of reference signals.

26. The apparatus of claim 25, further comprising:
means for identifying a reference signal from the set of reference signals, wherein the resource for transmitting the scheduling request is based at least in part on the reference signal from the set of reference signals.

27. The apparatus of claim 25, wherein:
the reference signal from the set of reference signals is at least one of a primary synchronization signal (PSS), a secondary synchronization signal (SSS), a demodulation reference signal (DMRS) for a physical broadcast channel (PBCH), a beam reference signal (BRS), channel state indicator reference signal (CSI-RS), a mobility reference signal (MRS), a cell specific reference signal (CRS), or a combination thereof.

28. The apparatus of claim 22, further comprising:
means for determining, based at least in part on the resource, at least one of a transmission time, a set of subcarriers, a cyclic shift, or a sequence index, wherein the scheduling request is transmitted using the transmission time, the set of subcarriers, the cyclic shift, the sequence index, or a combination thereof.

29. The apparatus of claim 22, further comprising:
means for receiving, from the base station, at least one of a transmission time, a set of subcarriers, a cyclic shift, a sequence index, wherein the scheduling request is transmitted using the transmission time, the set of subcarriers, the cyclic shift, the sequence index, or a combination thereof.

30. The apparatus of claim 22, wherein:
the scheduling request comprises a sequence repeated a plurality of times over a plurality of symbol periods.

31. The apparatus of claim 22, wherein:
the scheduling request comprises a short PUCCH format.

32. The apparatus of claim 22, wherein:
the resource for transmitting the scheduling request is associated with a random access channel (RACH).

33. The apparatus of claim 32, further comprising:
means for identifying a frequency region associated with the RACH and a frequency region associated with scheduling requests that does not overlap with the frequency region associated with the RACH, wherein the scheduling request is transmitted using resources located within the frequency region associated with scheduling requests.

34. The apparatus of claim 32, further comprising:
means for identifying a cyclic prefix length for the scheduling request, wherein the cyclic prefix length comprises a long cyclic prefix length associated with the RACH or a short cyclic prefix length associated with non-RACH transmissions.

35. An apparatus for wireless communication, comprising:
means for transmitting a reference signal to a user equipment (UE); and
means for receiving a scheduling request from the UE using a resource selected by the UE based at least in part on the reference signal.

36. The apparatus of claim 35, further comprising:
means for transmitting a grant for transmitting a buffer status report (BSR) in response to the scheduling request; and
means for receiving the BSR from the UE using resources indicated in the grant.

37. The apparatus of claim 36, wherein:
the resources indicated in the grant comprises physical uplink shared channel (PUSCH) resources, physical uplink control channel (PUCCH) resources, or both.

38. The apparatus of claim 35, wherein:
the resource for receiving the scheduling request is associated with a random access channel (RACH).

39. The apparatus of claim 38, further comprising:
means for identifying a frequency region associated with the RACH and a frequency region associated with scheduling requests that does not overlap with the frequency region associated with the RACH, wherein the scheduling request is received using resources located within the frequency region associated with scheduling requests.

40. The apparatus of claim 38, further comprising:
means for identifying a cyclic prefix length for the scheduling request, wherein the cyclic prefix length comprises a long cyclic prefix length associated with the RACH or a short cyclic prefix length associated with non-RACH transmissions.

41. The apparatus of claim 35, further comprising:
means for transmitting an indication of at least one of a cyclic shift, a set of subcarriers, or a sequence index to the UE, wherein the scheduling request is received using the cyclic shift, the set of subcarriers, the sequence index, or combinations thereof.

42. The apparatus of claim 35, wherein:
the scheduling request comprises a sequence repeated a plurality of times over a plurality of symbol periods.

43. An apparatus for wireless communication, in a system comprising:
a processor;
memory in electronic communication with the processor; and
instructions stored in the memory and operable, when executed by the processor, to cause the apparatus to:
receive a reference signal from a base station;
identify a resource for transmitting a scheduling request to the base station, wherein the resource for transmitting the scheduling request is based at least in part on the reference signal; and
transmit the scheduling request to the base station using the resource.

44. The apparatus of claim 43, wherein the instructions are further executable by the processor to:
receive a grant for transmitting a buffer status report (BSR) in response to the scheduling request; and
transmit the BSR to the base station using the resource indicated in the grant.

45. The apparatus of claim 44, wherein:
the resource indicated in the grant comprise physical uplink shared channel (PUSCH) resources, physical uplink control channel (PUCCH) resources, or both.

46. The apparatus of claim 43, wherein:
the reference signal from the base station comprises one or more reference signals from a set of reference signals.

47. The apparatus of claim 46, wherein the instructions are further executable by the processor to:
identify a reference signal from the set of reference signals, wherein the resource for transmitting the scheduling request is based at least in part on the reference signal from the set of reference signals.

48. The apparatus of claim 46, wherein:
the reference signal from the set of reference signals is at least one of a primary synchronization signal (PSS), a secondary synchronization signal (SSS), a demodulation reference signal (DMRS) for a physical broadcast channel (PBCH), a beam reference signal (BRS), channel state indicator reference signal (CSI-RS), a mobility reference signal (MRS), a cell specific reference signal (CRS), or a combination thereof.

49. The apparatus of claim 43, wherein the instructions are further executable by the processor to:
determine, based at least in part on the resource, at least one of a transmission time, a set of subcarriers, a cyclic shift, or a sequence index, wherein the scheduling request is transmitted using the transmission time, the set of subcarriers, the cyclic shift, the sequence index, or a combination thereof.

50. The apparatus of claim 43, wherein the instructions are further executable by the processor to:
receive, from the base station, at least one of a transmission time, a set of subcarriers, a cyclic shift, a sequence index, wherein the scheduling request is transmitted using the transmission time, the set of subcarriers, the cyclic shift, the sequence index, or a combination thereof.

51. The apparatus of claim 43, wherein:
the scheduling request comprises a sequence repeated a plurality of times over a plurality of symbol periods.

52. The apparatus of claim 43, wherein:
the scheduling request comprises a short PUCCH format.

53. The apparatus of claim 43, wherein:
the resource for transmitting the scheduling request is associated with a random access channel (RACH).

54. The apparatus of claim 53, wherein the instructions are further executable by the processor to:
identify a frequency region associated with the RACH and a frequency region associated with scheduling requests that does not overlap with the frequency region associated with the RACH, wherein the scheduling request is transmitted using resources located within the frequency region associated with scheduling requests.

55. The apparatus of claim 53, wherein the instructions are further executable by the processor to:
identify a cyclic prefix length for the scheduling request, wherein the cyclic prefix length comprises a long cyclic prefix length associated with the RACH or a short cyclic prefix length associated with non-RACH transmissions.

56. An apparatus for wireless communication, in a system comprising:
a processor;
memory in electronic communication with the processor; and
instructions stored in the memory and operable, when executed by the processor, to cause the apparatus to:
transmit a reference signal to a user equipment (UE); and
receive a scheduling request from the UE using a resource selected by the UE based at least in part on the reference signal.

57. The apparatus of claim 56, wherein the instructions are further executable by the processor to:
transmit a grant for transmitting a buffer status report (BSR) in response to the scheduling request; and
receive the BSR from the UE using resources indicated in the grant.

58. The apparatus of claim 57, wherein:
the resources indicated in the grant comprises physical uplink shared channel (PUSCH) resources, physical uplink control channel (PUCCH) resources, or both.

59. The apparatus of claim 56, wherein:
the resource for receiving the scheduling request is associated with a random access channel (RACH).

60. The apparatus of claim 59, wherein the instructions are further executable by the processor to:
identify a frequency region associated with the RACH and a frequency region associated with scheduling requests that does not overlap with the frequency region associated with the RACH, wherein the scheduling request is received using resources located within the frequency region associated with scheduling requests.

61. The apparatus of claim 59, wherein the instructions are further executable by the processor to:
identify a cyclic prefix length for the scheduling request, wherein the cyclic prefix length comprises a long cyclic prefix length associated with the RACH or a short cyclic prefix length associated with non-RACH transmissions.

62. The apparatus of claim 56, wherein the instructions are further executable by the processor to:
transmit an indication of at least one of a cyclic shift, a set of subcarriers, or a sequence index to the UE, wherein the scheduling request is received using the cyclic shift, the set of subcarriers, the sequence index, or combinations thereof.

63. The apparatus of claim 56, wherein:
the scheduling request comprises a sequence repeated a plurality of times over a plurality of symbol periods.

64. A non-transitory computer readable medium storing code for wireless communication, the code comprising instructions executable by a processor to:
receive a reference signal from a base station;
identify a resource for transmitting a scheduling request to the base station, wherein the resource for transmitting the scheduling request is based at least in part on the reference signal; and
transmit the scheduling request to the base station using the resource.

65. The non-transitory computer-readable medium of claim 64, wherein the instructions are further executable by the processor to:
receive a grant for transmitting a buffer status report (BSR) in response to the scheduling request; and
transmit the BSR to the base station using the resource indicated in the grant.

66. The non-transitory computer-readable medium of claim 65, wherein:
the resource indicated in the grant comprise physical uplink shared channel (PUSCH) resources, physical uplink control channel (PUCCH) resources, or both.

67. The non-transitory computer-readable medium of claim 64, wherein:
the reference signal from the base station comprises one or more reference signals from a set of reference signals.

68. The non-transitory computer-readable medium of claim 67, wherein the instructions are further executable by the processor to:
identify a reference signal from the set of reference signals, wherein the resource for transmitting the scheduling request is based at least in part on the reference signal from the set of reference signals.

69. The non-transitory computer-readable medium of claim 67, wherein:
the reference signal from the set of reference signals is at least one of a primary synchronization signal (PSS), a secondary synchronization signal (SSS), a demodulation reference signal (DMRS) for a physical broadcast channel (PBCH), a beam reference signal (BRS), channel state indicator reference signal (CSI-RS), a mobility reference signal (MRS), a cell specific reference signal (CRS), or a combination thereof.

70. The non-transitory computer-readable medium of claim 64, wherein the instructions are further executable by the processor to:
determine, based at least in part on the resource, at least one of a transmission time, a set of subcarriers, a cyclic shift, or a sequence index, wherein the scheduling request is transmitted using the transmission time, the set of subcarriers, the cyclic shift, the sequence index, or a combination thereof.

71. The non-transitory computer-readable medium of claim 64, wherein the instructions are further executable by the processor to:
receive, from the base station, at least one of a transmission time, a set of subcarriers, a cyclic shift, a sequence index, wherein the scheduling request is transmitted using the transmission time, the set of subcarriers, the cyclic shift, the sequence index, or a combination thereof.

72. The non-transitory computer-readable medium of claim 64, wherein:
the scheduling request comprises a sequence repeated a plurality of times over a plurality of symbol periods.

73. The non-transitory computer-readable medium of claim 64, wherein:
the scheduling request comprises a short PUCCH format.

74. The non-transitory computer-readable medium of claim 64, wherein:
the resource for transmitting the scheduling request is associated with a random access channel (RACH).

75. The non-transitory computer-readable medium of claim 74, wherein the instructions are further executable by the processor to:
identify a frequency region associated with the RACH and a frequency region associated with scheduling requests that does not overlap with the frequency region associated with the RACH, wherein the scheduling request is transmitted using resources located within the frequency region associated with scheduling requests.

76. The non-transitory computer-readable medium of claim 74, wherein the instructions are further executable by the processor to:
identify a cyclic prefix length for the scheduling request, wherein the cyclic prefix length comprises a long cyclic prefix length associated with the RACH or a short cyclic prefix length associated with non-RACH transmissions.

77. A non-transitory computer readable medium storing code for wireless communication, the code comprising instructions executable by a processor to:
transmit a reference signal to a user equipment (UE); and
receive a scheduling request from the UE using a resource selected by the UE based at least in part on the reference signal.

78. The non-transitory computer-readable medium of claim 77, wherein the instructions are further executable by the processor to:
transmit a grant for transmitting a buffer status report (BSR) in response to the scheduling request; and
receive the BSR from the UE using resources indicated in the grant.

79. The non-transitory computer-readable medium of claim 78, wherein:
the resources indicated in the grant comprises physical uplink shared channel (PUSCH) resources, physical uplink control channel (PUCCH) resources, or both.

80. The non-transitory computer-readable medium of claim 77, wherein:
the resource for receiving the scheduling request is associated with a random access channel (RACH).

81. The non-transitory computer-readable medium of claim 80, wherein the instructions are further executable by the processor to:
identify a frequency region associated with the RACH and a frequency region associated with scheduling requests that does not overlap with the frequency region associated with the RACH, wherein the scheduling request is received using resources located within the frequency region associated with scheduling requests.

82. The non-transitory computer-readable medium of claim 80, wherein the instructions are further executable by the processor to:
identify a cyclic prefix length for the scheduling request, wherein the cyclic prefix length comprises a long cyclic prefix length associated with the RACH or a short cyclic prefix length associated with non-RACH transmissions.

83. The non-transitory computer-readable medium of claim 77, wherein the instructions are further executable by the processor to:
transmit an indication of at least one of a cyclic shift, a set of subcarriers, or a sequence index to the UE, wherein the scheduling request is received using the cyclic shift, the set of subcarriers, the sequence index, or combinations thereof.

84. The non-transitory computer-readable medium of claim 77, wherein:
the scheduling request comprises a sequence repeated a plurality of times over a plurality of symbol periods.
